(19) United States
(12) Patent Application Publication
(10) Pub. No.: US 2025/0321439 A1
(43) Pub. Date: Oct. 16, 2025

(54) OPTICAL MODULE

(71) Applicant: HISENSE BROADBAND MULTIMEDIA TECHNOLOGIES CO., LTD., Qingdao (CN)

(72) Inventors: Qiang ZHANG, Qingdao (CN); Qisheng ZHAO, Qingdao (CN); Shihai YANG, Qingdao (CN); Jiahui ZHAO, Qingdao (CN); Chunqiu ZHANG, Qingdao (CN); Yang LIU, Qingdao (CN); Yifan QU, Qingdao (CN)

(21) Appl. No.: 19/253,299

(22) Filed: Jun. 27, 2025

Related U.S. Application Data
(63) Continuation of application No. PCT/CN2023/119104, filed on Sep. 15, 2023.

(30) Foreign Application Priority Data
May 26, 2023 (CN) 202310610796.1
May 26, 2023 (CN) 202310613631.X
Jun. 13, 2023 (CN) 202310701617.5

(51) Int. Cl. G02F 1/01; G02B 6/42

(52) U.S. Cl. CPC G02F 1/0123; G02B 6/4271; G02B 6/4278; G02F 2203/50

(57) ABSTRACT

An optical module includes a circuit board and an optical emission component. A driver on the circuit board includes a first output terminal and a second output terminal which output a first modulation signal and a second modulation signal, respectively. In the optical emission component, a first modulation unit is connected to the first output terminal via a first path, a second modulation unit is connected to the second output terminal via a second path; the first modulation unit performs a first modulation on an optical signal according to the first modulation signal, the second modulation unit performs a second modulation on the optical signal according to the second modulation signal; and wherein the first modulation and the second modulation are co-directional modulations.

The present disclosure is a Continuation Application of International Patent Application No. PCT/CN2023/119104, filed on Sep. 15, 2023, which claims priority to Chinese Patent Application No. 202310613631.X, filed with China National Intellectual Property Administration on May 26, 2023, Chinese Patent Application No. 202310610796.1, filed with China National Intellectual Property Administration on May 26, 2023, and Chinese Patent Application No. 202310701617.5, filed with China National Intellectual Property Administration on Jun. 13, 2023, the entire content of which is incorporated herein by reference.

### FIELD OF THE INVENTION

The present disclosure relates to the field of optical fiber communication technology, in particular to an optical module.

### BACKGROUND OF THE INVENTION

With the development of new services and application models such as cloud computing, mobile Internet, and video, the progress of optical communication technology has become more and more important. In optical communication technology, optical modules are tools to achieve the conversion between optical signals and electrical signals, serving as one of the key devices in optical communication equipment and occupying a central position in optical communication.

### SUMMARY OF THE INVENTION

An optical module provided in the present disclosure includes a circuit board and an optical emission component. A surface of the circuit board is arranged thereon with a driver, wherein the driver includes a first output terminal and a second output terminal, and the driver is configured to output a first modulation signal through the first output terminal, and output a second modulation signal through the second output terminal. The optical emission component is electrically connected to the circuit board and includes a laser assembly, wherein the laser assembly includes a first modulation unit and a second modulation unit; an optical output terminal of the first modulation unit is optically connected to an optical input terminal of the second modulation unit; the first modulation unit is connected to the first output terminal via a first path, and the second modulation unit is connected to the second output terminal via a second path; the first modulation unit is configured to perform a first modulation according to the first modulation signal and output a first optical signal; the second modulation unit is configured to perform a second modulation on the first optical signal according to the second modulation signal; and the first modulation and the second modulation are co-directional modulations such that optical power modulations of optical signals corresponding to a same bit signal are superimposed; and the first modulation and the second modulation are co-directional modulations that include: the first modulation signal and the second modulation signal are differential signals with opposite phases, and modulation characteristics of the first modulation unit and the second modulation unit are different; or, the first modulation signal and the second modulation signal are differential signals with opposite phases, and the modulation characteristics of the first modulation unit and the second modulation unit are the same, and a phase inversion circuit is connected in series on the first path or the second path; or, the first modulation signal and the second modulation signal are signals with the same phase, and the modulation characteristics of the first modulation unit and the second modulation unit are the same; or, the first modulation signal and the second modulation signal are signals with the same phase, and the modulation characteristics of the first modulation unit and the second modulation unit are different, and a phase inversion circuit is connected in series on the first path or the second path.

### BRIEF DESCRIPTION OF THE DRAWINGS

To illustrate the technical solutions in the present disclosure more clearly, a brief introduction to the drawings that need to be used in some embodiments of the present disclosure will be provided below. Apparently, the drawings described below are merely the drawings in some embodiments of the present disclosure. Those of ordinary skill in the art can also derive other drawings from these drawings. Furthermore, the drawings described below can be regarded as schematic diagrams and are not intended to limit the actual dimensions of the products, the actual processes of the methods, or the actual timing of the signals involved in the embodiments of the present disclosure.

FIG. 1 is a partial structural diagram of an optical communication system according to some embodiments of the present disclosure;

FIG. 2 is a partial structural diagram of a host computer according to some embodiments of the present disclosure;

FIG. 3 is a schematic structural diagram of an optical module according to some embodiments of the present disclosure;

FIG. 4 is an exploded view of an optical module according to some embodiments of the present disclosure;

FIG. 5 is a schematic diagram of an internal structure of an optical module according to some embodiments of the present disclosure;

FIG. 6 is a schematic structural diagram of an optical emission component according to some embodiments of the present disclosure;

FIG. 7 is a schematic diagram of a partial structure of an optical emission component according to some embodiments of the present disclosure;

FIG. 8 is a principle diagram of connection between a laser assembly and a driver according to some embodiments of the present disclosure;

FIG. 9 is a schematic structural diagram of a laser assembly according to some embodiments of the present disclosure;

FIG. 10 is a circuit diagram for a laser assembly according to some embodiments of the present disclosure;

FIG. 11 is another circuit diagram for a laser assembly according to some embodiments of the present disclosure;

FIG. 12 is a principle diagram of signal modulation of the laser assembly in FIG. 11;

FIG. 13 is yet another circuit diagram for a laser assembly according to some embodiments of the present disclosure;

FIG. 14 is a principle diagram of signal modulation of the laser assembly in FIG. 13;

FIG. 15 is a fourth circuit diagram for a laser assembly according to some embodiments of the present disclosure;

FIG. 16 is a fifth circuit diagram for a laser assembly according to some embodiments of the present disclosure;

FIG. 17 is a schematic exploded view of FIG. 16;

FIG. 18 is an exploded view of an optical emission component according to some embodiments of the present disclosure;

FIG. 19 is a schematic diagram of a partial structure of an optical emission component according to some embodiments of the present disclosure;

FIG. 20 is a schematic partial exploded view of an optical emission component according to some embodiments of the present disclosure;

FIG. 21 is a schematic structural diagram of an electrical connector according to some embodiments of the present disclosure;

FIG. 22 is a schematic structural diagram of a base according to some embodiments of the present disclosure;

FIG. 23 is a usage state diagram of a base according to some embodiments of the present disclosure;

FIG. 24 is a structural diagram of an optical module test system according to some embodiments;

FIG. 25 is a structural diagram of an optical module without a shell according to some embodiments;

FIG. 26 is another structural diagram of an optical module without a shell according to some embodiments;

FIG. 27 is an assembly diagram of a laser chip, a power chip, and an MCU according to some embodiments;

FIG. 28 is a structural diagram of an MCU according to some embodiments;

FIG. 29 is a flowchart 1 of a debugging method according to some embodiments;

FIG. 30 is a flowchart 2 of a debugging method according to some embodiments; and

FIG. 31 is a flowchart 3 of a debugging method according to some embodiments.

### DETAILED DESCRIPTION OF THE EMBODIMENTS

In optical communication technology, in order to establish information transmission between information processing devices, it is necessary to load information onto light and use the propagation of light to achieve the transmission of information. Here, the light loaded with information is an optical signal. When the optical signal is transmitted in the information transmission devices, the loss of optical power can be reduced, such that high-speed, long-distance, and low-cost information transmission can be achieved. The signals that the information processing devices are able to recognize and process are electrical signals. The information processing devices usually include optical network units (ONUs), gateways, routers, switches, mobile phones, computers, servers, tablet computers, televisions, etc. The information transmission devices usually include optical fibers and optical waveguides.

The optical modules can achieve the conversion between optical signals and electrical signals from the information processing devices and the information transmission devices. For example, at least one of an optical signal input terminal or an optical signal output terminal of an optical module is connected to an optical fiber, and at least one of an electrical signal input or an electrical signal output terminal of the optical module is connected to an optical network unit; a first optical signal from the optical fiber is transmitted to the optical module, and the optical module converts the first optical signal into a first electrical signal and transmits the first electrical signal to the optical network unit; and a second electrical signal from the optical network unit is transmitted to the optical module, and the optical module converts the second electrical signal into a second optical signal and transmits the second optical signal to the optical fiber. Since information can be transmitted through electrical signals between a plurality of information processing devices, at least one information processing device in the plurality of information processing devices is required to be directly connected to the optical module, and all information processing devices are not required to be directly connected to the optical module. Here, the information processing device directly connected to the optical module is referred to as a host computer of the optical module. In addition, the optical signal input terminal or the optical signal output terminal of the optical module can be referred to as an optical port, and the electrical signal input or the electrical signal output terminal of the optical module can be referred to as an electrical port.

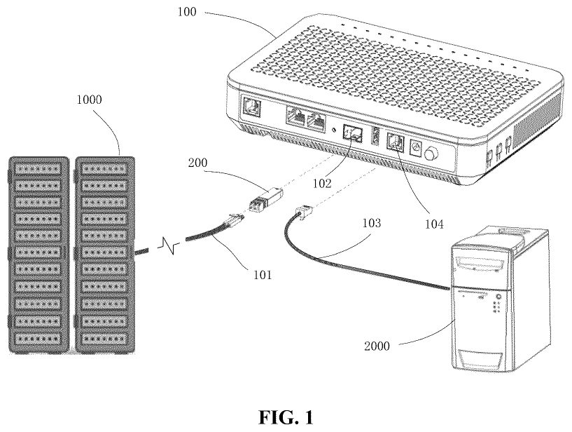

FIG. 1 is a partial structural diagram of an optical communication system according to some embodiments of the present disclosure. As shown in FIG. 1, the optical communication system primarily includes a remote information processing device 1000, a local information processing device 2000, a host computer 100, an optical module 200, an optical fiber 101 and a network cable 103.

One end of the optical fiber 101 extends in the direction of the remote information processing device 1000, and the other end of the optical fiber 101 is connected to the optical module 200 via an optical port of the optical module 200. An optical signal can undergo total reflection in the optical fiber 101, and the propagation of the optical signal in the total reflection direction can nearly maintain original optical power. The optical signal undergoes multiple total reflections in the optical fiber 101 to transmit an optical signal from the remote information processing device 1000 to the optical module 200 or to transmit an optical signal from the optical module 200 to the remote information processing device 1000, thereby achieving long-distance and low-power-loss information transmission.

The optical communication system may include one or more optical fibers 101, and the optical fiber 101 is detachably or fixedly connected to the optical module 200. The host computer 100 is configured to provide a data signal to the optical module 200, receive a data signal from the optical module 200, or monitor or control a working state of the optical module 200.

The host computer 100 includes a generally cuboid-shaped housing and an optical module interface 102 arranged on the housing. The optical module interface 102 is configured to be connected to the optical module 200, enabling the host computer 100 to establish a one-way or two-way electrical signal connection with the optical module 200.

The host computer 100 further includes an external electrical interface that can be connected to an electrical signal network. For example, the external electrical interface includes a universal serial bus (USB) interface or a network cable interface 104. The network cable interface 104 is configured to be connected to the network cable 103, enabling the host computer 100 to establish a one-way or two-way electrical signal connection with the network cable 103. One end of the network cable 103 is connected to the local information processing device 2000, and the other end of the network cable 103 is connected to the host computer 100, thereby establishing an electrical signal connection between the local information processing device 2000 and the host computer 100 via the network cable 103. For example, a third electrical signal sent by the local information processing device 2000 is transmitted to the host computer 100 via the network cable 103. The host computer 100 generates a second electrical signal according to the third electrical signal. The second electrical signal from the host computer 100 is transmitted to the optical module 200. The optical module 200 converts the second electrical signal into a second optical signal and transmits the second optical signal to the optical fiber 101. The second optical signal is transmitted through the optical fiber 101 to the remote information processing device 1000. For example, a first optical signal from the remote information processing device 1000 is transmitted through the optical fiber 101. The first optical signal from the optical fiber 101 is transmitted to the optical module 200. The optical module 200 converts the first optical signal into a first electrical signal, and then the optical module 200 transmits the first electrical signal to the host computer 100. The host computer 100 generates a fourth electrical signal according to the first electrical signal and transmits the fourth electrical signal to the local information processing device 2000. It should be noted that the optical module is a tool to achieve the conversion between optical signals and electrical signals. In the conversion between the optical signals and the electrical signals, the information remains unchanged, and the encoding and decoding methods for the information may vary.

In addition to the optical network unit, the host computer 100 further includes an optical line terminal (OLT), an optical network terminal (ONT), or a data center server.

FIG. 2 is a partial structural diagram of a host computer according to some embodiments of the present disclosure. In order to clearly show the connection relationship between the optical module 200 and the host computer 100, FIG. 2 shows only the structure of the host computer 100 related to the optical module 200. As shown in FIG. 2, the host computer 100 further includes a printed circuit board (PCB) 105 arranged in the housing, a cage 106 arranged on the surface of the PCB 105, a heat sink 107 arranged on the cage 106, and an electrical connector arranged inside the cage 106. The electrical connector is configured to be connected to the electrical port of the optical module 200. The heat sink 107 has protruding structures such as fins that enlarge the heat dissipation area.

The optical module 200 is inserted into the cage 106 of the host computer 100, and the optical module 200 is fixed by the cage 106. Heat generated by the optical module 200 is conducted to the cage 106 and then diffused through the heat sink 107. After the optical module 200 is inserted into the cage 106, the electrical port of the optical module 200 is connected to the electrical connector inside the cage 106, such that the optical module 200 establishes a two-way electrical signal connection with the host computer 100. In addition, the optical port of the optical module 200 is connected to the optical fiber 101, such that the optical module 200 establishes a two-way optical signal connection with the optical fiber 101.

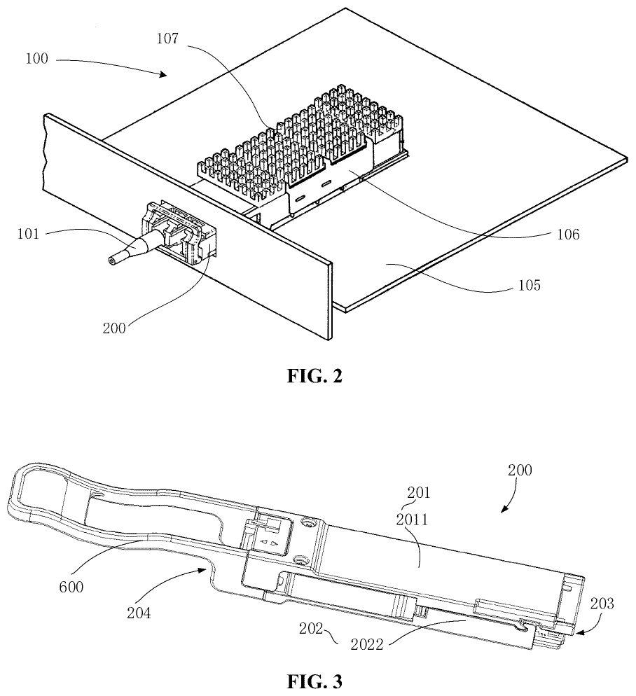

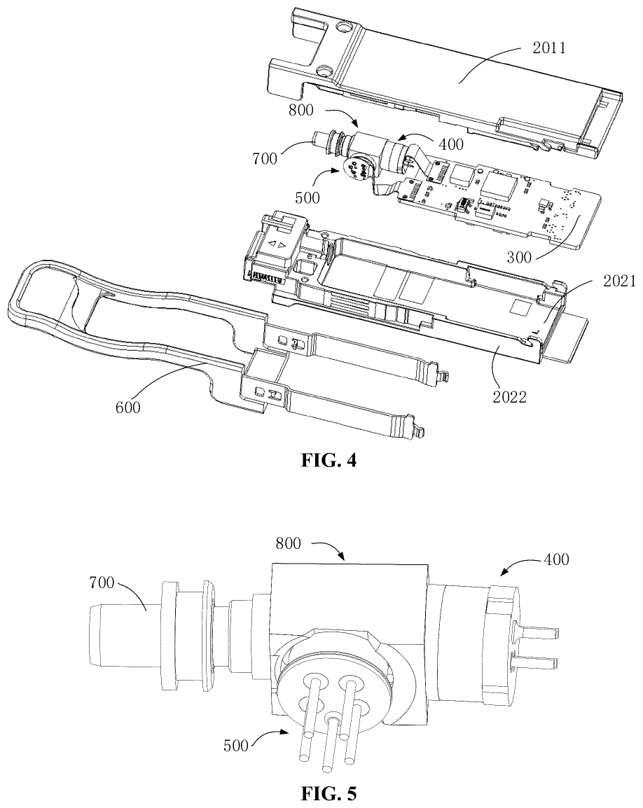

FIG. 3 is a structural diagram of an optical module according to some embodiments of the present disclosure. FIG. 4 is a schematic exploded view of an optical module according to some embodiments of the present disclosure. As shown in FIG. 3 and FIG. 4, the optical module 200 includes a shell, and a circuit board 300, an optical emission component 400 and an optical reception component 500 which are arranged in the shell. However, the present disclosure is not limited to this. In some embodiments, the optical module 200 includes either an optical emission component 400 or an optical reception component 500.

The shell includes an upper shell 201 and a lower shell 202, where the upper shell 201 covers the lower shell 202 to form the shell with two openings; and the outer contour of the shell is generally square.

In some embodiments, the lower shell 202 includes a base plate 2021 and two lower side plates 2022 located at two sides of the base plate 2021 and perpendicular to the base plate 2021; and the upper shell 201 includes a cover plate 2011, where the cover plate 2011 covers the two lower side plates 2022 of the lower shell 202 to form the shell.

In some embodiments, the lower shell 202 includes a base plate 2021 and two lower side plates 2022 located at two sides of the base plate 2021 and perpendicular to the base plate 2021; and the upper shell 201 includes a cover plate 2011 and two upper side plates located at two sides of the cover plate 2011 and perpendicular to the cover plate 2011, where the two upper side plates and the two lower side plates 2022 are combined to ensure that the upper shell 201 covers the lower shell 202.

The direction of a connecting line between the opening 203 and the opening 204 may be consistent with the length direction of the optical module 200 or may be inconsistent with the length direction of the optical module 200. For example, the opening 203 is located at the end part of the optical module 200 (the right end of FIG. 3), and the opening 204 is also located at the end part of the optical module 200 (the left end of FIG. 3). Alternatively, the opening 203 is located at the end part of the optical module 200, and the opening 204 is located at the side part of the optical module 200. The opening 203 is an electrical port, and a gold finger of the circuit board 300 extends out from the electrical port and is inserted into the host computer 100 (e.g., an optical network unit); and the opening 204 is an optical port, which is configured to be connected to the optical fiber 101 such that the optical fiber 101 is connected to the optical emission component 400 and/or the optical reception component 500 in the optical module 200.

The assembly method of combining the upper shell 201 with the lower shell 202 is adopted, such that the circuit board 300, the optical emission component 400, the optical reception component 500 and other components can be conveniently mounted in the shell, and these devices can be packaged by the upper shell 201 and the lower shell 202 for protection. In addition, when the circuit board 300, the optical emission component 400, the optical reception component 500 and other components are assembled, it is convenient for the deployment of positioning parts, heat dissipation parts and electromagnetic shielding parts of these devices, and is conducive to the automatic production.

In some embodiments, the upper shell 201 and the lower shell 202 are generally made of metal materials, which is conducive to electromagnetic shielding and heat dissipation.

In some embodiments, the optical module 200 further includes an unlocking component 600 located outside the shell. The unlocking component 600 is configured to achieve a fixed connection between the optical module 200 and the host computer, or to release the fixed connection between the optical module 200 and the host computer.

Exemplarily, the unlocking component 600 is located at the outer side of the two lower side plates 2022 of the lower shell 202, and includes a clamping component that matches the cage 106 of the host computer 100. When the optical module 200 is inserted into the cage 106, the optical module 200 is fixed in the cage 106 by the clamping component of the unlocking component 600; and when the unlocking component 600 is pulled, the clamping component of the unlocking component 600 moves accordingly, such that the connection relationship between the clamping component and the host computer is changed to release the fixation of the optical module 200 to the host computer, thereby pulling out the optical module 200 from the cage 106. The circuit board 300 includes circuit traces, electronic components, and chips, where

the electronic components and the chips are connected according to the circuit design through the circuit traces to implement the functions such as power supply, electrical signal transmission and grounding. The electronic components may include, for example, capacitors, resistors, transistors, and metal-oxide-semiconductor field-effect transistors (MOSFETs). The chips may include, for example, microcontroller units (MCUs), laser driving chips, transimpedance amplifiers (TIAs), limiting amplifiers (LIAs), clock and data recovery (CDR) chips, power management chips, and digital signal processing (DSP) chips. Exemplarily, a driver 310 is arranged on the circuit board 300. The driver 310 outputs a modulation signal to drive the optical emission component 400, enabling the optical emission component 400 to generate an emission optical signal. In some embodiments, the driver 310 includes a first output terminal and a second output terminal. The driver 310 outputs a first modulation signal through the first output terminal. The driver 310 outputs a second modulation signal through the second output terminal. Exemplarily, the first modulation signal and the second modulation signal are differential signals, that is, the first modulation signal and the second modulation signal have the same amplitude but opposite phases; or the first modulation signal and the second modulation signal are identical.

The circuit board 300 is generally a rigid circuit board. The rigid circuit board can also achieve the bearing effect because of its relatively hard material, for example, the rigid circuit board can smoothly carry the above-mentioned electronic components and chips. The rigid circuit board can also be inserted into the electrical connector in the cage 106 of the host computer 100.

The circuit board 300 further includes a gold finger formed on the end surface thereof, where the gold finger consists of a plurality of pins that are independent of each other. The circuit board 300 is inserted into the cage 106, and the gold finger is connected to the electrical connector in the cage 106. The gold finger may be arranged only on the surface of one side of the circuit board 300 (such as the upper surface shown in FIG. 4), or may be arranged on the surfaces of the upper and lower sides of the circuit board 300 to provide more pins, so as to adapt to the occasion where a large number of pins are required. The gold finger is configured to establish an electrical connection with the host computer to achieve power supply, grounding, two-wire inter-integrated circuit (I2C) signal transmission, data signal transmission, etc. Certainly, flexible circuit boards are also used in some optical modules. Flexible circuit boards are generally used in conjunction with rigid circuit boards as a supplement to rigid circuit boards.

At least one of the optical emission component 400 or the optical reception component 500 is located at one side of the circuit board 300 away from the gold finger.

In some embodiments, the optical emission component 400 and the optical reception component 500 are physically separated from the circuit board 300 and then are electrically connected to the circuit board 300 via corresponding flexible circuit boards or electrical connectors.

In some embodiments, at least one of the optical emission component or the optical reception component may be directly arranged on the circuit board 300. For example, at least one of the optical emission component or the optical reception component may be arranged on the surface or the side edge of the circuit board 300.

In some embodiments, the optical emission component 400 is configured to emit the optical signal, and the optical reception component 500 is configured to receive the optical signal. Exemplarily, the optical emission component 400 and the optical reception component 500 are combined together to form an integrated optical transceiver component, that is, the optical emission component 400 and the optical reception component 500 are combined together through an optical accommodation component 800. Certainly, in some embodiments of the present disclosure, the optical emission component 400 and the optical reception component 500 are separated, that is, the optical emission component 400 and the optical reception component 500 are not combined together through the optical accommodation component 800.

FIG. 5 is a schematic diagram of an internal structure of an optical module according to some embodiments of the present disclosure. As shown in FIG. 5, in some embodiments, the optical module 200 further includes an optical accommodation component 800. The optical accommodation component 800 is connected to the optical emission component 400 or the optical reception component 500. A cavity is formed inside the optical accommodation component 800. The optical accommodation component 800 accommodates an optical device such as an optical filter and a reflecting mirror by the cavity. The optical device is configured to adjust the transmission direction of the optical signal. FIG. 4 and FIG. 5 show a coaxially packaged optical module, where the optical emission component 400 or the optical reception component 500 adopts a coaxial packaging structure. However, in the embodiments of the present disclosure, the optical emission component 400 or the optical reception component 500 is not limited to the coaxial packaging structure.

In some embodiments, one end of the optical accommodation component 800 is connected to an optical fiber adapter 700, the other end of the optical accommodation component 800 is connected to the optical emission component 400, and the side edge of the optical accommodation component 800 is connected to the optical reception component 500. The optical emission component 400 and the optical reception component 500 are packaged together by the optical accommodation component 800, such that the total volume of other devices for adapting to the optical emission component 400 and the optical reception component 500 in the optical module can be conveniently controlled, thereby saving internal space of the optical module. Certainly, in some embodiments, only the optical emission component 400 may be arranged on the optical accommodation component 800.

In some embodiments, the optical fiber adapter 700 is configured to be connected to the optical fiber 101. The optical signal generated by the optical emission component 400 is transmitted to the optical accommodation component 800, then is transmitted to the optical fiber adapter 700, and is transmitted to the optical fiber 101 by the optical fiber adapter 700. The optical signal input terminal to the optical module 200 through the optical fiber 101 is transmitted to the optical accommodation component 800 by the optical fiber adapter 700 and then is transmitted to the optical reception component 500 by the optical accommodation component 800.

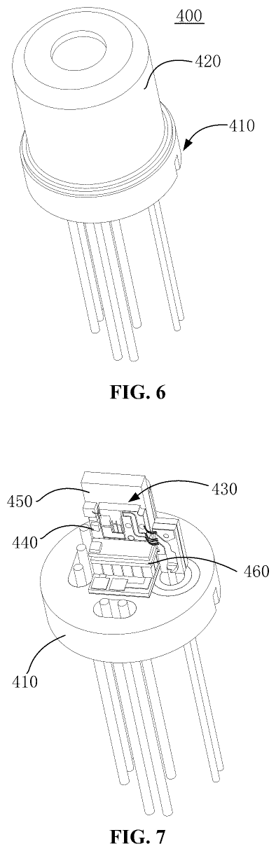

FIG. 6 is a schematic structural diagram of an optical emission component according to some embodiments of the present disclosure. FIG. 7 is a schematic diagram of a partial structure of an optical emission component according to some embodiments of the present disclosure. A coaxially packaged optical emission component is shown in FIG. 6 and FIG. 7. As shown in FIG. 6 and FIG. 7, in some embodiments, the optical emission component 400 includes a header 410 and a cap 420. The cap 420 covers the header 410. The cap 420 is fixedly connected to the header 410 to form a cavity. A laser assembly 430 is arranged in the cavity. The laser assembly 430 is arranged on the top surface of the header 410 and is configured to generate an optical signal. A thermo electric cooler (TEC), a thermistor, or a base may also be arranged in the cavity.

In some embodiments, as shown in FIG. 7, the header 410 is further provided with a TEC 440, a base 450, and a thermistor 460. The laser assembly 430 is arranged on the base 450, the thermistor 460 is arranged on the base 450, and the base 450 is arranged on the TEC 440. Certainly, in the embodiments of the present disclosure, the assembly form of devices on the header 410 is not limited to this. The laser assembly 430 may also be directly arranged on the TEC 440.

In the embodiments of the present disclosure, the laser assembly 430 is electrically connected to the first output terminal and the second output terminal of the driver 310, enabling the laser assembly 430 to perform two co-directional modulations according to the first modulation signal and the second modulation signal during the process of generating the emission optical signal. Furthermore, during the two co-directional modulations for generating the emission optical signal, the optical power modulations of the optical signals corresponding to the same bit signal are superimposed, such that in the optical signal, the position with high optical power is higher and the position with low optical power is lower, thereby making the difference between the high optical power and the low optical power in the emission optical signal output by the laser assembly more obvious, and increasing the extinction ratio of the laser assembly. Specifically, the first modulation enables a specified extinction ratio to be generated, and the second modulation further increases the extinction ratio on the basis of the extinction ratio generated in the first modulation. That is, the extinction ratios generated in the two modulations are superimposed, thereby increasing the extinction ratio of the laser assembly 430.

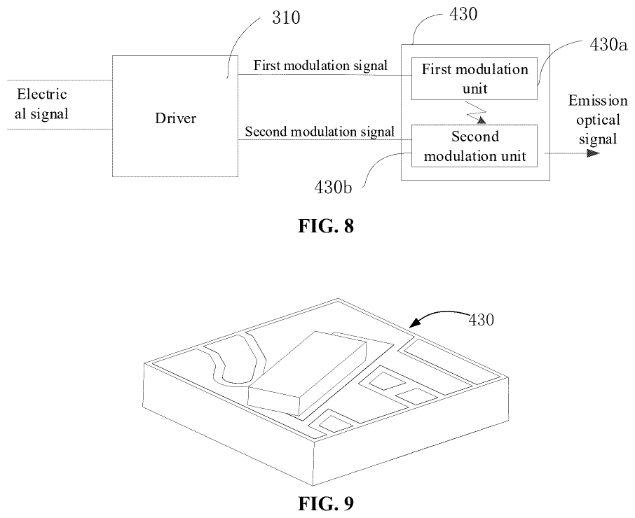

FIG. 8 is a principle diagram of connection between a laser assembly and a driver according to some embodiments of the present disclosure. A principle structure of a laser assembly is shown in FIG. 8. As shown in FIG. 8, the laser assembly 430 includes a first modulation unit 430a and a second modulation unit 430b. The first modulation unit 430a is connected to the first output terminal of the driver 310 via a first path, and the second modulation unit 430b is connected to the second output terminal of the driver 310 via a second path.

In some embodiments, the modulation characteristic of the first modulation unit 430a is different from that of the second modulation unit 430b, or the modulation characteristic of the first modulation unit 430a is the same as that of the second modulation unit 430b. The modulation characteristic refers to a modulation state of the optical signal by the modulation unit in a high-level or low-level state. For example, a high-level bit signal is modulated to generate an optical signal with high optical power, and a low-level bit signal is modulated to generate an optical signal with low optical power (the above modulation characteristic is referred to as a first modulation characteristic); or a high-level bit signal is modulated to generate an optical signal with low optical power, and a low-level bit signal is modulated to generate an optical signal with high optical power (the above modulation characteristic is referred to as a second modulation characteristic). When the modulation characteristic of the first modulation unit 430a is different from that of the second modulation unit 430b, the modulation characteristic of the first modulation unit 430a is the first modulation characteristic, and the modulation characteristic of the second modulation unit 430b is the second modulation characteristic; or the modulation characteristic of the first modulation unit 430a is the second modulation characteristic, and the modulation characteristic of the second modulation unit 430b is the first modulation characteristic.

Exemplarily, taking an example where the modulation characteristic of the first modulation unit 430a is the first modulation characteristic and the modulation characteristic of the second modulation unit 430b is the second modulation characteristic, the first modulation unit 430a performs modulation based on the high-level bit signal to generate a high-power optical signal, and the second modulation unit 430b performs modulation based on the high-level bit signal to generate a low-power optical signal. Therefore, the first modulation characteristic and the second modulation characteristic respond oppositely to bit signals with the same level attribute. Thus, when the modulation characteristic of the first modulation unit 430a is different from that of the second modulation unit 430b, it can also be considered that the modulation characteristics of these two modulation units are opposite.

In some embodiments, when the first modulation signal and the second modulation signal are differential signals, if the modulation characteristic of the first modulation unit 430a is the same as that of the second modulation unit 430b, a phase inversion circuit is arranged on the first path or the second path to achieve two co-directional modulations. In some embodiments, when the first modulation signal and the second modulation signal are identical, if the modulation characteristic of the first modulation unit 430a is different from that of the second modulation unit 430b, a phase inversion circuit is arranged on the first path or the second path to achieve two co-directional modulations. The phase inversion circuit is configured to invert the phase of the first modulation signal or the second modulation signal, such that the modulation signal after phase inversion has the same phase as the modulation signal before phase inversion, thereby enabling the first modulation unit 430a and the second modulation unit 430b to perform two co-directional modulations during the process of generating the emission optical signal.

In some other embodiments, when the first modulation signal and the second modulation signal are differential signals, if the modulation characteristic of the first modulation unit 430a is different from that of the second modulation unit 430b, two modulations are co-directional modulations, such that two co-directional modulations can be achieved without arranging a phase inversion circuit. Alternatively, when the first modulation signal and the second modulation signal are identical, if the modulation characteristic of the first modulation unit 430a is the same as that of the second modulation unit 430b, two modulations are co-directional modulations, so that two co-directional modulations can also be achieved without arranging a phase inversion circuit.

Exemplarily, the first modulation unit 430a is a distributed feedback laser diode (LD) or an electro-absorption modulator (EAM), and the second modulation unit 430b is an EAM or a semiconductor optical amplifier (SOA). The modulation characteristic of the LD is the first modulation characteristic, the modulation characteristic of the EAM is the second modulation characteristic, and the modulation characteristic of the SOA is the first modulation characteristic. Exemplarily, when the first modulation unit 430a is the LD and the second modulation unit 430b is the EAM, the modulation characteristic of the first modulation unit 430a is different from that of the second modulation unit 430b; when the first modulation unit 430a is the EAM and the second modulation unit 430b is the SOA, the modulation characteristic of the first modulation unit 430a is different from that of the second modulation unit 430b; and when the first modulation unit 430a is the EAM and the second modulation unit 430b is the EAM, the modulation characteristic of the first modulation unit 430a is the same as that of the second modulation unit 430b.

The specific structure of the laser assembly will be described in detail below.

FIG. 9 is a schematic structural diagram of a laser assembly according to some embodiments of the present disclosure. As shown in FIG. 9, the laser assembly 430 is a laser assembly including an electro-absorption modulated laser (EML) and an SOA. The SOA is located at an output terminal of the EML and is configured to increase the light intensity of an optical signal output by the EML. The EML includes an EAM and an LD. The LD emits a direct current light. The EAM performs electro-absorption modulation on the direct current light emitted by the LD to obtain an optical signal. In some embodiments, the laser assembly 430, which includes an EML and an SOA, is configured to meet the link budget requirements that cannot be satisfied by emitted optical power of a standalone EML. Exemplarily, for an optical line terminal (OLT) in a 50G passive optical network (PON), in order to reuse the existing optical distribution network (ODN) and achieve a link budget equivalent to that of a 10G PON, the sensitivity decreases due to the increased downlink receiver rate. To compensate for the link budget, an optical power of an output light of an emission laser needs to be increased, such that the laser assembly 430 including an EML and an SOA is used.

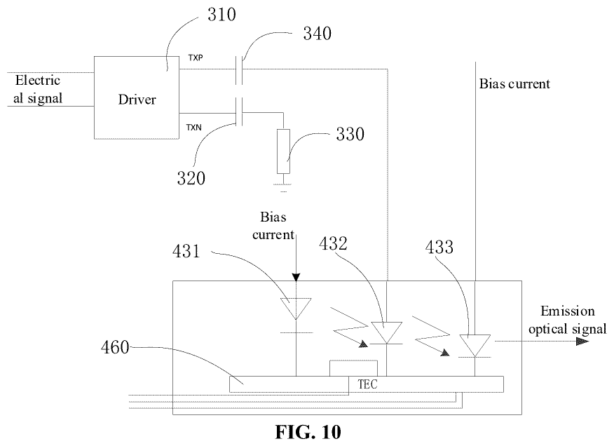

FIG. 10 is a circuit diagram for a laser assembly according to some embodiments of the present disclosure. As shown in FIG. 10, the laser assembly 430 includes an LD 431, an EAM 432, and an SOA 433. A bias current is input to an anode of the LD 431. The bias current is configured to enable the LD 431 to generate a direct current light. Exemplarily, the anode of the LD 431 is connected to a power management chip, and the bias current is input to the LD 431 through the power management chip. The EAM 432 is located at an optical output terminal of the LD 431. The driver 310 is in driving connection with an anode of the EAM 432 to input a modulation signal to the EAM 432, such that the EAM 432 modulates the light emitted by the LD 431, and the EML outputs an optical signal. The SOA 433 is located at an optical signal output terminal of the EAM 432. A bias current is input to an anode of the SOA 433. The bias current is configured to enable the SOA 433 to amplify the optical signal output by the EML. Exemplarily, the anode of the SOA 433 is connected to the power management chip, and the bias current is input to the SOA 433 through the power management chip. In some embodiments, to ensure the bandwidth of the laser assembly 430, the positions of the EAM 432 and the SOA 433 cannot be interchanged. It should be noted that in the embodiments of the present disclosure, there is merely provided an example where the laser assembly 430 is configured as an optical emission component 400 with a coaxial packaging structure. The laser assembly 430 provided in the embodiments of the present disclosure is not limited to the coaxially packaged optical emission component 400, and the laser assembly 430 can also be configured as an optical emission component 400 with a micro-optical packaging structure.

In some embodiments, the driver 310 is a differential input and differential output driver. A differential signal received by the driver 310 is input through the gold finger of the optical module, processed by the DSP chip or the CDR chip, and then transmitted to the driver 310. A non-inverting output terminal of the driver 310 is connected to the anode of the EAM 432. To prevent reflection of a signal line and avoid ringing that affects working of the EAM 432, an inverting output terminal of the driver 310 is terminated with a capacitor and a resistor. Exemplarily, the inverting output terminal of the driver 310 is sequentially connected to a first capacitor 320 and a resistor 330. One end of the first capacitor 320 is connected to the inverting output terminal of the driver 310, the other end of the first capacitor 320 is connected to one end of the resistor 330, and the other end of the resistor 330 is grounded.

In some embodiments, a second capacitor 340 is arranged between the non-inverting output terminal of the driver 310 and the anode of the EAM 432. One end of the second capacitor 340 is connected to the non-inverting output terminal of the driver 310, and the other end of the second capacitor 340 is connected to the anode of the EAM 432. In some embodiments, the driver 310 outputs a modulation signal, which is loaded onto the anode of the EAM 432 in an AC-coupled manner through the non-inverting output terminal of the driver 310, thereby modulating an electrical signal onto an optical carrier. The SOA 433 amplifies an optical signal modulated by the EAM 432. The optical power emitted by the LD 431 is modulated by the EAM 432 to achieve the conversion between the electrical signal and the optical signal. Exemplarily, the driver 310 is a 50G driver, and the LD 431 and the EAM 432 form a 50G EML. Certainly, the EML formed by the LD 431 and the EAM 432 in the embodiments of the present disclosure is not limited to 50G and may also be 10G, 100G, etc.

In some embodiments, the driver 310 adopts complementary metal oxide semiconductor (CMOS) technology and is integrated into the DSP chip. Certainly, in the embodiments of the present disclosure, the driver 310 is not limited to being integrated into the DSP chip and may also be a separate driver chip. The signal amplitude at the output terminal of the driver 310 using the CMOS technology is limited and cannot be made very high, typically reaching only 1.5 V. In the data communication field, this amplitude is sufficient to meet the extinction ratio requirement of ≥3.5 dB for the optical module. In the PON field, the laser assembly 430 requires an extinction ratio (ER)≥7 dB. To meet the ER≥7 dB requirement, the amplitude of a driving signal output by the driver 310 needs to be increased to at least 2 V, which is currently difficult to achieve with the CMOS technology. Alternatively, SiGe technology can be used, but the SiGe technology is difficult to integrate with the CMOS technology, such that the driver 310 cannot be integrated into the DSP chip that uses the CMOS technology, and two separate chips, namely the driver 310 and the DSP chip need to be used in the optical module, resulting in a complex circuit scheme in the optical module.

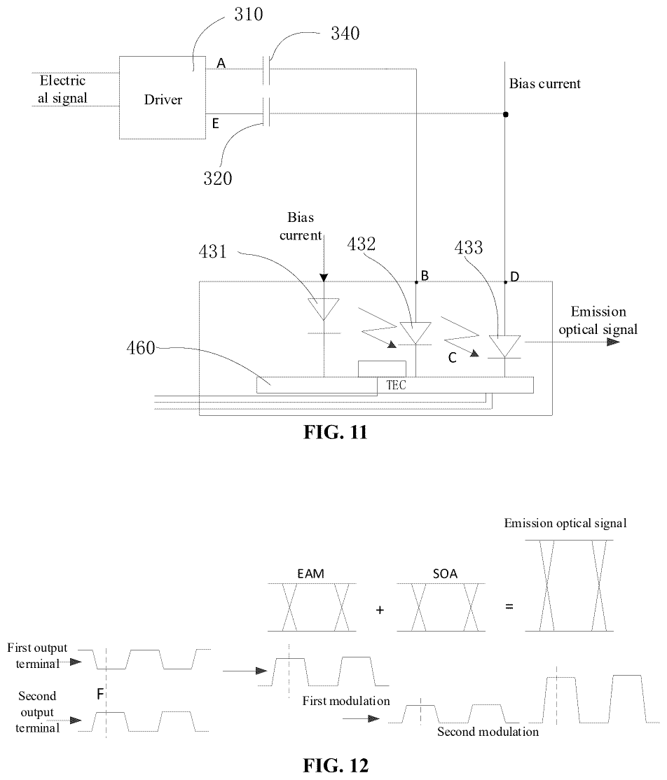

FIG. 11 is another circuit diagram for a laser assembly according to some embodiments of the present disclosure. As shown in FIG. 11, in some embodiments, the laser assembly 430 includes an LD 431, an EAM 432 and an SOA 433. A bias current is input to an anode of the LD 431, thereby enabling the LD 431 to emit light. The first modulation unit 430a includes an EAM 432. The second modulation unit 430b includes an SOA 433. The modulation characteristic of the EAM 432 is different from that of the SOA 433. The first modulation signal and the second modulation signal are differential signals. The EAM 432 is located at an optical output terminal of the LD 431. The first output terminal of the driver 310 is connected to a positive terminal of the EAM 432 via the first path to input a first modulation signal to the EAM 432, such that the EAM 432 performs a first modulation on the direct current light emitted by the LD 431 according to the first modulation signal to generate a first optical signal, and the EML outputs the optical signal. The SOA 433 is located at an optical signal output terminal of the EAM 432. A bias current is input to a positive terminal of the SOA 433 and the positive terminal of the SOA 433 is also connected to the second output terminal of the driver 310 via the second path, such that the SOA 433 performs a second modulation on the first optical signal according to a second modulation signal and amplifies the optical signal subjected to second modulation. Therefore, the combination of the modulation of the light emitted by the LD 431 by the EAM 432 and the remodulation of the optical signal by the SOA 433 enables the optical power modulations of the optical signals corresponding to the same bit signal to be superimposed, such that in the optical signal, the position with high optical power is higher and the position with low optical power is lower, thereby making the difference between the high optical power and the low optical power in the emission optical signal output by the laser assembly more obvious, and increasing the extinction ratio of the laser assembly.

In some embodiments, the first output terminal of the driver 310 is a non-inverting output terminal of the driver 310, and the second output terminal of the driver 310 is an inverting output terminal. Certainly, in the embodiments of the present disclosure, the first output terminal of the driver 310 may also be the inverting output terminal of the driver 310, and the second output terminal of the driver 310 may also be the non-inverting output terminal of the driver 310. Exemplarily, the non-inverting output terminal of the driver 310 is connected to the positive terminal of the EAM 432, and the inverting output terminal of the driver 310 is connected to the positive terminal of the SOA 433. In some instances, the positive terminal of the SOA 433 is connected to a power management chip, the bias current is input to the SOA 433 by the power management chip, and the inverting output terminal of the driver 310 is connected between the positive terminal of the SOA 433 and the power management chip.

FIG. 12 is a principle diagram of signal modulation of the laser assembly in FIG. 11. The effect of the EAM 432 performing first modulation according to a first modulation signal and the SOA 433 performing second modulation according to a second modulation signal is shown in FIG. 12. As shown in FIG. 12, in the embodiments of the present disclosure, the optical signal modulated by the EAM 432 is remodulated by the SOA 433, such that the direct current light generated by the LD 431 undergoes two modulations. The two modulations enable the optical power modulations of the optical signals corresponding to the same bit signal (e.g., F) to be superimposed, such that in the optical signal, the position with high optical power is higher and the position with low optical power is lower, thereby making the difference between the high optical power and the low optical power in the emission optical signal output by the laser assembly more obvious. During the process of emitting the optical signal by the optical module, the extinction ratio of the emission optical signal is positively correlated with the amplitude of the modulation signal loaded onto the EAM 432. The amplitude of the electrical signal output by the driver 310 is limited, and the characteristics of the EAM 432 may also saturate. When the direct current light generated by the LD 431 undergoes the first modulation by the EAM 432, the extinction ratio of the laser assembly cannot continue to increase after reaching a specified value. Therefore, in the embodiments of the present disclosure, the direct current light generated by the LD 431 undergoes co-directional modulation sequentially through the EAM 432 and the SOA 433. The two modulations enable the extinction ratios of the laser assembly to be superimposed, thereby further increasing the extinction ratio of the laser assembly 430 on the basis of performing first modulation by only the EAM 432.

In some embodiments, the two co-directional modulations performed by the EAM 432 and the SOA 433 mean that the time taken for one path of the same bit signal output by the first output terminal and the second output terminal of the driver 310 to be transmitted to the EAM 432, modulated by the EAM 432 to generate an optical signal and transmitted to the SOA 433 is the same as the time taken for the other of the same bit signal to be transmitted to the SOA 433, thereby ensuring bit alignment during the two modulation processes.

The EAM 432 is a negative voltage working device. For a level of 1, its working voltage is negative and close to 0 V; and for a level of 0, its working voltage is negative and far from 0 V. For the SOA 433, the electrical signal output by the driver 310 is a voltage-type signal, with a high amplitude for the level of 1 and a low amplitude for the level of 0. When a high level is applied to the SOA 433, the optical signal power corresponding to the level of 1 continues to increase; and when a low level is applied to the SOA 433, the optical signal power corresponding to the level of 0 continues to decrease. Furthermore, the optical signal undergoes two co-directional modulations by the EAM 432 and the SOA 433, such that the extinction ratios generated in the two modulations are superimposed, thereby increasing the extinction ratio of the emission optical signal.

In some embodiments, to ensure bit alignment, the time for the optical signal generated after the first modulation of the electrical signal output by the first output terminal by the EAM 432 to be transmitted to the SOA 433 is the same as the time for the electrical signal output by the second output terminal to reach the SOA 433. In some embodiments, the second path is slightly longer than the first path, such that the difference between the first path and the second path is used to compensate for the time for the optical signal subjected to first modulation to be transmitted from the EAM 432 to the SOA 433.

Exemplarily, the driver 310 includes a first output terminal A and a second output terminal E. For the positive terminal position B of the EAM 432, the positive terminal position D of the SOA 433, and the distance C between the EAM 432 and the SOA 433 in the laser assembly 430, the length of AB+C equals ED, such that the electrical signal received by the positive terminal of the EAM 432 is bit-aligned with the electrical signal received by the SOA 433, thereby ensuring signal transmission quality. In some embodiments, the wiring length of the signal line on the control circuit board 300 is controlled to ensure that the length of AB+C equals ED.

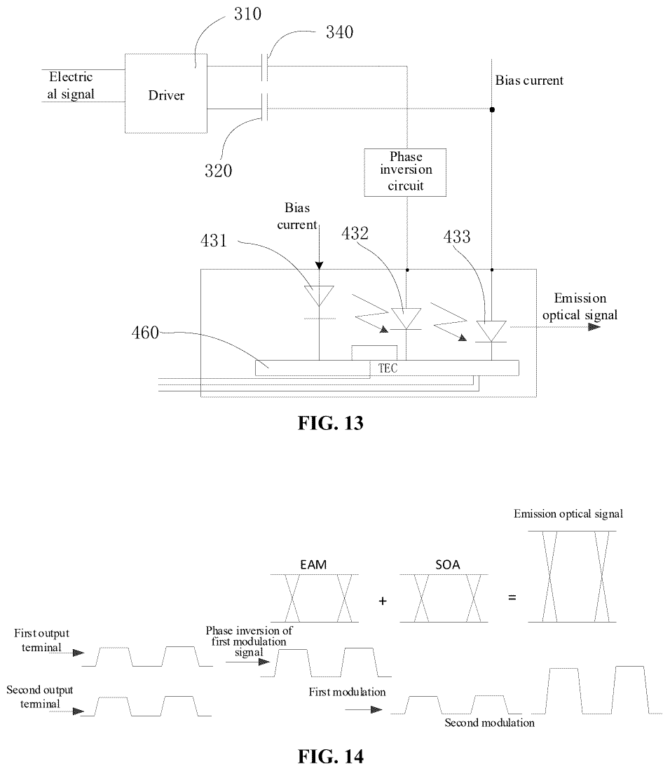

FIG. 13 is yet another circuit diagram for a laser assembly according to some embodiments of the present disclosure. As shown in FIG. 13, the laser assembly 430 includes an LD 431, an EAM 432, and an SOA 433. The first output terminal of the driver 310 is connected to the EAM 432 via the first path, and the second output terminal of the driver 310 is connected to the SOA 433 via the second path. The first modulation signal and the second modulation signal output by the driver 310 are identical signals. A phase inversion circuit is arranged on the first path. The phase inversion circuit is configured to invert the phase of the first modulation signal. The EAM 432 performs a first modulation on the direct current light output by the LD 431 according to the first modulation signal after phase inversion to generate a first optical signal. Exemplarily, the phase inversion circuit inverts the phase of the first modulation signal by 180 degrees.

FIG. 14 is a principle diagram of signal modulation of the laser assembly in FIG. 13. Another effect of the EAM 432 performing first modulation according to a first modulation signal and the SOA 433 performing second modulation according to a second modulation signal is shown in FIG. 14. As shown in FIG. 14, the EAM 432 performs a first modulation on the direct current light output by the LD 431 according to the first modulation signal after phase inversion to generate a first optical signal, and the SOA 433 performs a second modulation on the first optical signal. The two modulations enable the optical power modulations of the optical signals corresponding to the same bit signal to be superimposed, such that in the optical signal, the position with high optical power is higher and the position with low optical power is lower, thereby making the difference between the high optical power and the low optical power in the emission optical signal output by the laser assembly more obvious. During the first modulation by the laser assembly 430, a specified extinction ratio is generated, and the second modulation further increases the extinction ratio on the basis of the extinction ratio generated in the first modulation, such that the extinction ratios generated in the two modulations are superimposed, thereby increasing the extinction ratio of the laser assembly 430.

Certainly, in the embodiments of the present disclosure, the phase inversion circuit is not limited to being arranged on the first path and can also be arranged on the second path. When the phase inversion circuit is arranged on the second path, the phase inversion circuit inverts the phase of the second modulation signal, and the SOA 433 performs a second modulation on the first optical signal generated by the modulation of the EAM 432 according to the second modulation signal after phase inversion. In the embodiments of the present disclosure, for any unspecified details in the specific implementation process of the driver 310 driving the EAM 432 and the SOA 433, reference can be made to the specific implementation process of the laser assembly 430 shown in the embodiment of FIG. 11.

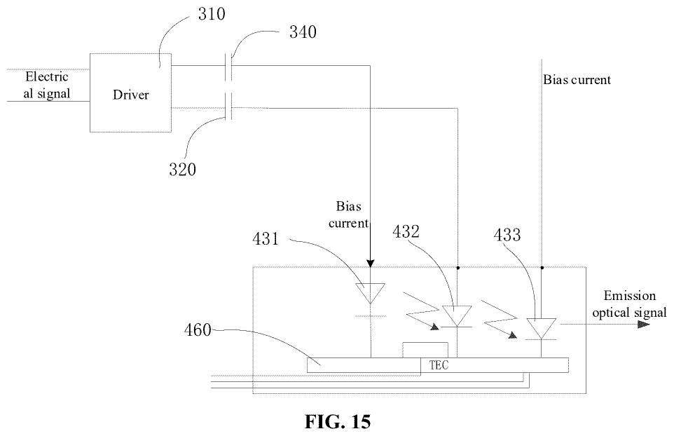

FIG. 15 is a fourth circuit diagram for a laser assembly according to some embodiments of the present disclosure. As shown in FIG. 15, the laser assembly 430 includes an LD 431 and an EAM 432. The EAM 432 is located at an optical output terminal of the LD 431. The first modulation unit 430a includes an LD 431. The second modulation unit 430b includes an EAM 432. The modulation characteristic of the LD 431 is different from the debugging attribute of the EAM 432. The first output terminal of the driver 310 is connected to a positive terminal of the LD 431 via the first path, and the second output terminal of the driver 310 is connected to a positive terminal of the EAM 432 via the second path.

In some embodiments, when the first modulation signal and the second modulation signal output by the driver 310 are differential signals, the LD 431 performs direct modulation (first modulation) according to the first modulation signal to generate a first optical signal, and the EAM 432 performs a second modulation on the first optical signal according to the second modulation signal.

In some embodiments, when the first modulation signal and the second modulation signal output by the driver 310 are identical, a phase inversion circuit is arranged on either the first path or the second path. Exemplarily, a phase inversion circuit is arranged on the first path. The phase inversion circuit inverts the phase of the first modulation signal, the LD 431 directly modulates the first modulation signal after phase inversion to generate a first optical signal, and the EAM 432 performs a second modulation on the first optical signal according to the second modulation signal. Alternatively, a phase inversion circuit is arranged on the second path. The phase inversion circuit inverts the phase of the second modulation signal, and the EAM 432 performs a second modulation on a first optical signal according to the second modulation signal after phase inversion.

In the embodiments of the present disclosure, the first modulation performed by the LD 431 and the second modulation performed by the EAM 432 enable the laser assembly 430 to perform two modulations during the process of generating the emission optical signal, and enable the optical power modulations of the optical signals corresponding to the same bit signal to be superimposed, such that in the optical signal, the position with high optical power is higher and the position with low optical power is lower, thereby making the difference between the high optical power and the low optical power in the emission optical signal output by the laser assembly 430 more obvious. During the first modulation by the laser assembly 430, a specified extinction ratio is generated, and the second modulation further increases the extinction ratio on the basis of the extinction ratio generated in the first modulation, such that the extinction ratios generated in the two modulations are superimposed, thereby increasing the extinction ratio of the laser assembly 430.

An output terminal of the EAM 432 is provided with the SOA 433, and a bias current is input to the positive terminal of the SOA 433, enabling the SOA 433 to amplify optical power of the optical signal modulated by the EAM 432.

In the embodiments of the present disclosure, for any unspecified details regarding the process in which the driver 310 drives the LD 431 and the EAM 432 to perform two co-directional modulations, reference can be made to the specific implementation process of the laser assembly 430 shown in the embodiment of FIG. 11.

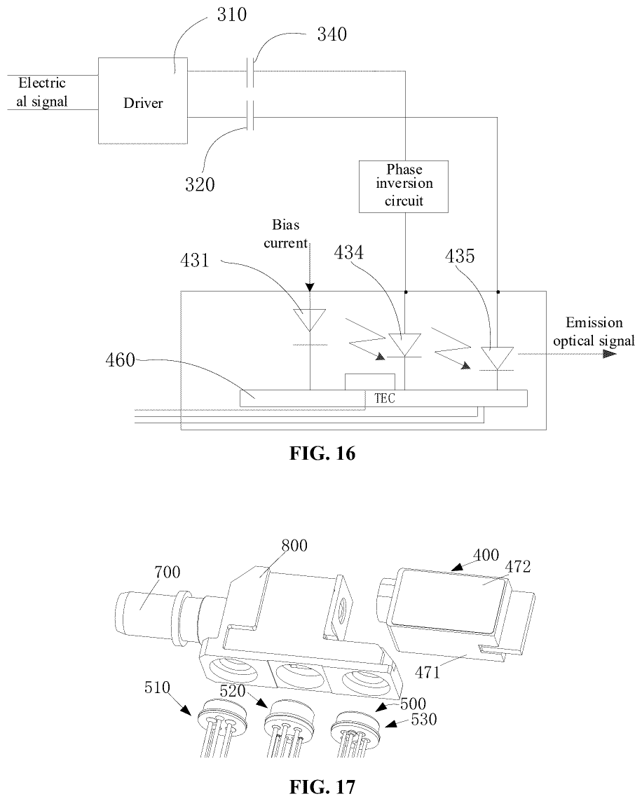

FIG. 16 is a fifth circuit diagram for a laser assembly according to some embodiments of the present disclosure. As shown in FIG. 16, the laser assembly 430 includes an LD 431, a first EAM 434, and a second EAM 435. The first modulation unit 430a includes a first EAM 434. The second modulation unit 430b includes a second EAM 435. The modulation characteristic of the first EAM 434 is the same as the debugging attribute of the second EAM 435. A bias current is input to a positive terminal of the LD 431, thereby enabling the LD 431 to emit light. The first output terminal of the driver 310 is connected to a positive terminal of the first EAM 434 via the first path, and the second output terminal of the driver 310 is connected to a positive terminal of the second EAM 435 via the second path.

In some embodiments, when the first modulation signal and the second modulation signal output by the driver 310 are differential signals, a phase inversion circuit is arranged on either the first path or the second path. Exemplarily, a phase inversion circuit is arranged on the first path. The phase inversion circuit inverts the phase of the first modulation signal, the first EAM 434 performs a first modulation on the direct current light emitted by the LD 431 according to the first modulation signal after phase inversion to generate a first optical signal, and the second EAM 435 performs a second modulation on the first optical signal according to the second modulation signal. Exemplarily, a phase inversion circuit is arranged on the first path. The phase inversion circuit inverts the phase of the second modulation signal, the first EAM 434 performs a first modulation on the direct current light emitted by the LD 431 according to the first modulation signal to generate a first optical signal, and the second EAM 435 performs a second modulation on the first optical signal according to the second modulation signal after phase inversion.

When the first modulation signal and the second modulation signal output by the driver 310 are identical, the first EAM 434 performs a first modulation on the direct current light output by the LD 431 according to the first modulation signal to generate a first optical signal, and the second EAM 435 performs a second modulation on the first optical signal according to the second modulation signal.

In the embodiments of the present disclosure, the first modulation performed by the first EAM 434 and the second modulation performed by the second EAM 435 enable the laser assembly 430 to perform two modulations during the process of generating the emission optical signal, and enable the optical power modulations of the optical signals corresponding to the same bit signal to be superimposed, such that in the optical signal, the position with high optical power is higher and the position with low optical power is lower, thereby making the difference between the high optical power and the low optical power in the emission optical signal output by the laser assembly 430 more obvious. During the first modulation by the laser assembly 430, a specified extinction ratio is generated, and the second modulation further increases the extinction ratio on the basis of the extinction ratio generated in the first modulation, such that the extinction ratios generated in the two modulations are superimposed, thereby increasing the extinction ratio of the laser assembly 430. An output terminal of the second EAM 435 is provided with the SOA 433, and a bias current is input to the positive terminal of the SOA 433, enabling the SOA 433 to amplify optical power of the optical signal modulated by the EAM 432.

In the embodiments of the present disclosure, for any unspecified details regarding the process in which the driver 310 drives the first EAM 434 and the second EAM 435 to perform two co-directional modulations, reference can be made to the specific implementation process of the laser assembly 430 shown in the embodiment of FIG. 11.

In some embodiments, a phase inversion circuit is arranged on the circuit board 300. The phase inversion circuit includes a phase inverter, which is arranged on the circuit board 300 and electrically connected to the circuit board 300. Exemplarily, the phase inverter is a NOT gate.

In some embodiments, the laser assembly 430 includes three modulation units. By providing three modulation signals, three modulations are performed during the process of generating the emission optical signal by the laser assembly. This enables the optical power modulations of the optical signals corresponding to the same bit signal to be superimposed, such that in the optical signal, the position with high optical power is higher and the position with low optical power is lower, thereby making the difference between the high optical power and the low optical power in the emission optical signal output by the laser assembly more obvious, and increasing the extinction ratio of the laser assembly. Exemplarily, three modulation signals are output by the driver 310 or by two drivers.

FIG. 17 is a schematic exploded view of FIG. 16. As shown in FIG. 17, the optical emission component 400 has a micro-optical packaging structure. The optical emission component 400 includes a light emission cavity 470. The light emission cavity 470 is configured to accommodate the laser assembly 430. The laser assembly 430 is the one provided in the aforementioned embodiments.

In some embodiments, the optical reception component 500 includes three optical reception assemblies, each of which has a coaxial packaging structure. The three optical reception assemblies are configured to enable the optical reception component 500 to receive reception optical signals of three wavelengths, that is, each optical reception assembly is configured to receive a reception optical signal of one wavelength. Exemplarily, the optical reception component 500 includes a first optical reception assembly 510, a second optical reception assembly 520 and a third optical reception assembly 530. The first optical reception assembly 510, the second optical reception assembly 520 and the third optical reception assembly 530 are sequentially arranged on the side edge of the optical accommodation component 800.

In some embodiments, the light emission cavity 470 includes not only the laser assembly 430 but also laser assemblies in other structural forms. Exemplarily, a first laser assembly and a second laser assembly are further included in the light emission cavity 470. The laser assembly 430, the first laser assembly and the second laser assembly are configured to enable the optical emission component 400 to generate emission optical signals of three different wavelengths.

In some embodiments, an optical filter, a reflecting mirror, a wavelength division multiplexing assembly, etc. are arranged in the optical accommodation component 800 to achieve the combining of optical paths for the emission optical signals of three wavelengths and the splitting of the reception optical signals of three wavelengths.

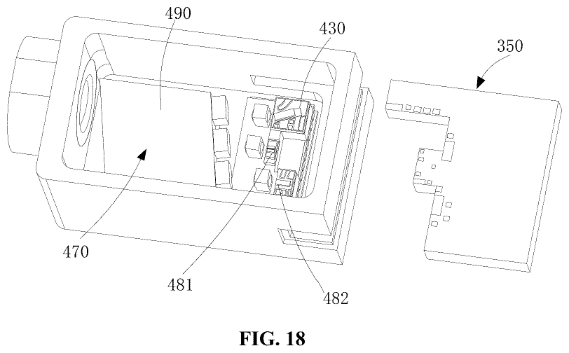

FIG. 18 is an exploded view of an optical emission component according to some embodiments of the present disclosure. As shown in FIG. 17 and FIG. 18, the light emission cavity 470 includes a casing 471 and an upper cover 472. An inner cavity is formed in the casing 471. The upper cover 472 is connected to the casing 471 in a covering manner. The upper cover 472 and the casing 471 form a relatively sealed cavity, namely the light emission cavity 470. One end of the light emission cavity 470 away from the optical accommodation component 800 is provided with an electrical connector 350. The electrical connector 350 is embedded at the end part of the light emission cavity 470. One end of the electrical connector 350 extends into the light emission cavity 470, and the other end of the electrical connector 350 is located outside the light emission cavity 470.

The laser assembly 430, the first laser assembly 481 and the second laser assembly 482 are arranged in the inner cavity of the casing 471. The laser assembly 430, the first laser assembly 481 and the second laser assembly 482 are arranged on the side edge of one end of the electrical connector 350.

A wavelength division multiplexer 490 is further arranged in the inner cavity of the casing 471. The wavelength division multiplexer 490 is configured to combine optical signals generated by the laser assembly 430, the first laser assembly 481 and the second laser assembly 482. In some embodiments, a lens is arranged in an optical path between each of the laser assembly 430, the first laser assembly 481 and the second laser assembly 482 and the wavelength division multiplexer 490. These lenses are used to collimate and converge the emission optical signals generated by the laser assembly 430, the first laser assembly 481 and the second laser assembly 482 correspondingly.

In some embodiments, the first laser assembly 481 is located between the laser assembly 430 and the second laser assembly 482. The optical output terminal directions of the laser assembly 430, the first laser assembly 481 and the second laser assembly 482 are oriented toward the wavelength division multiplexer 490. In some embodiments, the laser assembly 430 emits a first-wavelength optical signal, the first laser assembly 481 emits a second-wavelength optical signal, and the second laser assembly 482 emits a third-wavelength optical signal. The optical axes of the first-wavelength optical signal, the second-wavelength optical signal and the third-wavelength optical signal are parallel to the length extension direction of a second casing. Exemplarily, the wavelength range of the first-wavelength optical signal is 1,340-1,344 nm, for example, the wavelength of the first-wavelength optical signal is 1,342 nm. The wavelength range of the second-wavelength optical signal is 1,480-1,500 nm, for example, the wavelength of the second-wavelength optical signal is 1,490 nm. The wavelength range of the third-wavelength optical signal is 1,575-1,580 nm, for example, the wavelength of the third-wavelength optical signal is 1,577 nm.

In some embodiments, the transmission rate of the laser assembly 430 is greater than that of the second laser assembly 482, and the transmission rate of the second laser assembly 482 is greater than that of the first laser assembly 481. Exemplarily, the transmission rate of the laser assembly 430 is 50G, the transmission rate of the first laser assembly 481 is 2.5G, and the transmission rate of the second laser assembly 482 is 10G.

In some embodiments, the optical output terminal end surfaces of the laser assembly 430, the first laser assembly 481 and the second laser assembly 482 are not aligned, that is, the optical output terminal end surfaces of the laser assembly 430, the first laser assembly 481 and the second laser assembly 482 are located on different length faces of the casing 471.

In some embodiments, a TEC 460 is arranged in the inner cavity of the casing 471 and located below the laser assembly 430, the first laser assembly 481 and the second laser assembly 482. The TEC 460 is configured to adjust the temperatures of the laser assembly 430, the first laser assembly 481 and the second laser assembly 482.

In some embodiments, the top of the TEC 460 is fixedly connected to a base 450, and the laser assembly 430, the first laser assembly 481 and the second laser assembly 482 are arranged on the base 450.

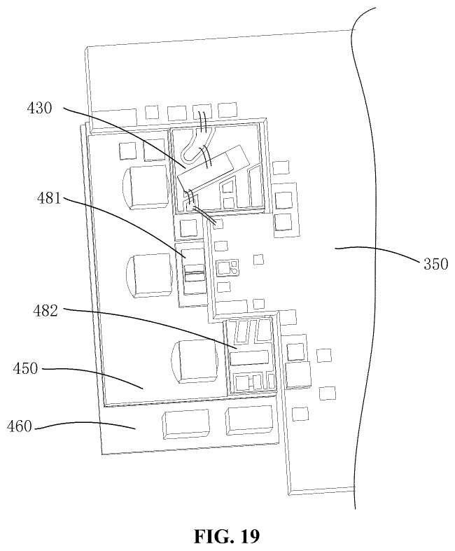

FIG. 19 is a schematic diagram of a partial structure of an optical emission component according to some embodiments of the present disclosure. In some embodiments, in the direction as shown in FIG. 19, a plurality of elongated portions are formed at the left end of the electrical connector 350. A gap is provided between the elongated portions, such that a plurality of side surfaces are formed at the left end of the electrical connector 350. The plurality of side surfaces are configured to be coordinately assembled with the side edges of the laser assembly 430, the first laser assembly 481 and the second laser assembly 482. This increases the contact area between the electrical connector 350 and the laser assembly 430, the first laser assembly 481 and the second laser assembly 482, allowing the left end of the electrical connector 350 to surround the laser assembly 430, the first laser assembly 481 and the second laser assembly 482. The edge of the top surface of the left end of the electrical connector 350 is provided with a plurality of pads. These pads are distributed on the edges of the side surfaces of the left end of the electrical connector 350 to facilitate a wire bonding connection between each of the laser assembly 430, the first laser assembly 481 and the second laser assembly 482 and the corresponding pad. Exemplarily, three side edges of the laser assembly 430 are close to three side surfaces of the left end of the electrical connector 350, enabling the left end of the electrical connector 350 to semi-surround the side edges of the laser assembly 430. One side edge of the first laser assembly 481 is close to one side surface of the left end of the electrical connector 350. Two side edges of the second laser assembly 482 are close to two side surfaces of the left end of the electrical connector 350. In some embodiments, the electrical connector 350 is a specially-shaped circuit board. Certainly, in the embodiments of the present disclosure, the electrical connector 350 may also be a ceramic substrate.

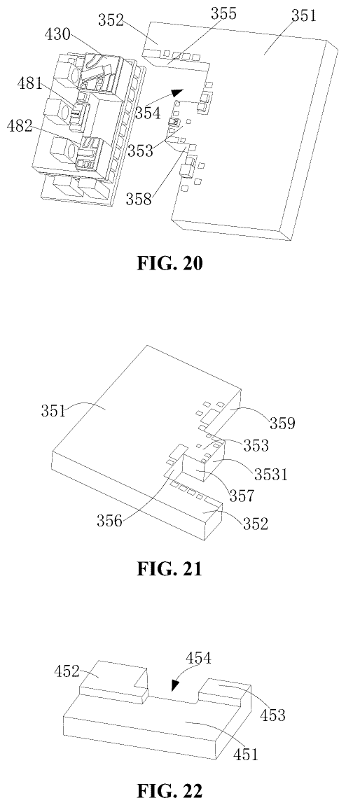

FIG. 20 is a schematic partial exploded view of an optical emission component according to some embodiments of the present disclosure. FIG. 21 is a schematic structural diagram of an electrical connector according to some embodiments of the present disclosure. As shown in FIG. 20 and FIG. 21, the electrical connector 350 includes an electrical connector body 351, and a first elongated portion 352 and a second elongated portion 353 which are located at one end of the electrical connector body 351. The first elongated portion 352 is located on the edge of the electrical connector 350, and the second elongated portion 353 is located in the middle of the electrical connector 350. A second gap 354 is formed between the first elongated portion 352 and the second elongated portion 353. A first side surface 355, a second side surface 356, a third side surface 357, a fourth side surface 3531, a fifth side surface 358 and a sixth side surface 359 are formed at one end of the electrical connector body 351. The first side surface 355 is located on the edge of the first elongated portion 352 close to the second gap 354. The second side surface 356 is located at the bottom of the second gap 354. The third side surface 357, the fourth side surface 3531 and the fifth side surface 358 are located on the edge of the second elongated portion 353. The sixth side surface 359 is located at one side of the second elongated portion 353 away from the first elongated portion 352 and is connected to the fifth side surface 358.

The first side surface 355, the second side surface 356 and the third side surface 357 surround the side edges of the laser assembly 430, enabling the three side edges of the laser assembly 430 to be close to the first side surface 355, the second side surface 356 and the third side surface 357 correspondingly. The fourth side surface 3531 is located on the side edge of the first laser assembly 481, enabling one side edge of the first laser assembly 481 to be close to the fourth side surface 3531. The fifth side surface 358 and the sixth side surface 359 surround the side edges of the second laser assembly 482, enabling the two side edges of the second laser assembly 482 to be close to the fifth side surface 358 and the sixth side surface 359 correspondingly.

The edge of the top surface of the electrical connector 350 connected to the first side surface 355, the second side surface 356, the third side surface 357, the fourth side surface 3531, the fifth side surface 358 and the sixth side surface 359 is provided with a plurality of pads. The laser assembly 430, the first laser assembly 481 and the second laser assembly 482 are in wire bonding connection with some pads on the edge of the top surface of the electrical connector 350 correspondingly. Some other pads are configured to mount electrical devices, such as backlight detectors, resistors, and capacitors.

FIG. 22 is a schematic structural diagram of a base according to some embodiments of the present disclosure. As shown in FIG. 22, the base 450 includes a base body 451. A first gap 454 is provided at one side of the base body 451. A first boss 452 is arranged at one side of the first gap 454 and at the top of the base body 451. A second boss 453 is arranged at the other side of the first gap 454 and at the top of the base body 451. The first boss 452 and the second boss 453 are higher than the top surface of the base body 451. In some embodiments, the first boss 452 and the second boss 453 have different heights.

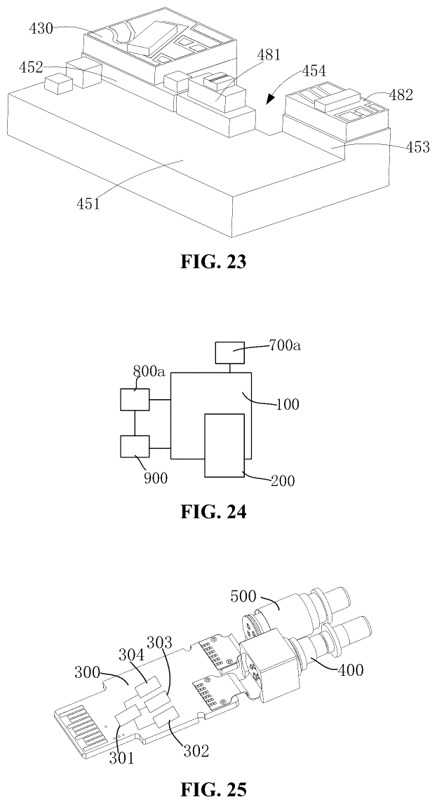

FIG. 23 is a usage state diagram of a base according to some embodiments of the present disclosure. As shown in FIG. 23, the laser assembly 430 is arranged on the first boss 452, the first laser assembly 481 is arranged on the top surface of the base body 451 and close to the edge of the first gap 454, and the second laser assembly 482 is arranged on the second boss 453. The first boss 452 and the second boss 453 are configured to coordinate the heights of the optical signals output by the laser assembly 430, the first laser assembly 481 and the second laser assembly 482, that is, they are configured to enable the optical signals output by the laser assembly 430, the first laser assembly 481 and the second laser assembly 482 to be located at the same or similar height. Additionally, the first boss 452 and the second boss 453 are configured to coordinate the heights of the pads on the laser assembly 430, the first laser assembly 481 and the second laser assembly 482 to facilitate controlling the wire bonding length with the electrical connector 350. Furthermore, the first gap 454 provided between the first boss 452 and the second boss 453 facilitates thermal isolation among the laser assembly 430, the first laser assembly 481 and the second laser assembly 482, while also simplifying assembly with the electrical connector 350 and saving assembly space.

In some embodiments, the electrical connector 350 is electrically connected to the circuit board 300 via a flexible circuit board. The first path between the first output terminal of the driver 310 and the EAM 432 sequentially passes through the circuit board 300, the flexible circuit board, the electrical connector 350, bonding wires between the laser assembly 430 and the electrical connector 350, and bonding wires on the laser assembly 430. The second path between the second output terminal of the driver 310 and the SOA 433 sequentially passes through the circuit board 300, the flexible circuit board, the electrical connector 350 and the bonding wires between the laser assembly 430 and the electrical connector 350. To facilitate bit alignment between the modulation signal from the EAM 432 and the modulation signal from the SOA 433, the length of the first path on the circuit board 300 is made equal to the length of the second path on the circuit board 300, the length of the first path on the electrical connector 350 is made equal to the length of the second path on the electrical connector 350, and the length of the bonding wires between the laser assembly 430 and the electrical connector 350 and the bonding wires on the laser assembly 430 in the first path is made equal to the length of the bonding wires between the laser assembly 430 and the electrical connector 350 in the second path. The difference between the length of the first path and the length of the second path on the flexible circuit board is adjusted to compensate for the time for the optical signal subjected to first modulation to be transmitted from the EAM 432 to the SOA 433.

During the first modulation by the laser assembly 430, a specified extinction ratio is generated, and the second modulation further increases the extinction ratio on the basis of the extinction ratio generated in the first modulation, such that the extinction ratios generated in the two modulations are superimposed, thereby increasing the extinction ratio of the laser assembly 430, improving the eye diagram quality of the optical signal output by the laser assembly 430, and enhancing the quality of the optical signal. Further provided in the present disclosure is another method for increasing the extinction ratio, thereby enabling the extinction ratio of the optical module to meet the eye diagram metrics.

FIG. 24 is a structural diagram of an optical module test system according to some embodiments. As shown in FIG. 24, in some embodiments, the optical module test system includes a test board 100, an optical module 200 arranged on the test board 100, a bit error rate tester 700a, an oscilloscope 800a, and a test host 900.

The test board 100 is provided with a hot-pluggable connector. The optical module 200 is inserted into the hot-pluggable connector to facilitate performance testing of the optical module 200. The test board 100 is provided with a high-speed signal connector. The bit error rate tester 700a is connected to the high-speed signal connector via a high-frequency electrical connection cable, so as to provide a high-frequency electrical signal to the test system.

The oscilloscope 800a is connected at one end to the optical module via an optical fiber and at the other end to the test host 900, and is configured to test the eye diagram performance of an emission end of the optical module. A display page of the oscilloscope 800a shows an optical power of an output light, an extinction ratio, and a template margin. The optical power of the output light refers to an average optical power.

The test board 100 is provided with a connection socket. The test host 900 is connected to the connection socket via a wire, so as to control the optical module for performance testing. The test host 900 is also connected to the oscilloscope 800a and is configured to obtain various metrics/parameters of an eye diagram, such as an optical power of an output light, an extinction ratio and a template margin.

After the bit error rate tester 700a sends the high-frequency electrical signal to the optical module 200, the test host 900 writes a first command value of a first instruction signal into the optical module 200. The optical module 200 determines a second bias current according to the first command value of the first instruction signal. The test host 900 writes a first command value of a second instruction signal into the optical module 200. The optical module adjusts the first bias current according to the first command value of the second instruction signal to ensure that the optical power of the output light is within a first preset range. When the test host 900 reads that the optical power of the output light is within the first preset range, the test host 900 writes a first command value of a third instruction signal into the optical module 200. The optical module adjusts a bias voltage according to the first command value of the third instruction signal to ensure that the extinction ratio is within a third preset range. When the test host 900 reads that the extinction ratio is within the third preset range, the test host 900 writes a second command value of the second instruction signal into the optical module 200. The optical module 200 readjusts the first bias current according to the second command value of the second instruction signal to ensure that the optical power of the output light is within a second preset range. When the test host 900 reads that the optical power of the output light is within the second preset range, the test host 900 writes a second command value of the third instruction signal into the optical module 200. The optical module 200 readjusts the bias voltage according to the second command value of the third instruction signal to ensure that the extinction ratio is within a fourth preset range. When the test host 900 reads that the template margin is greater than a preset value, the test host 900 writes a fourth instruction signal into the optical module 200. The optical module 200 stores the first command value of the first instruction signal, the second command value of the second instruction signal, and the second command value of the third instruction signal according to the fourth instruction signal. When the test host 900 reads that the template margin is less than the preset value, the test host 900 does not write the fourth instruction signal into the optical module 200 but writes a second command value or a third command value of the first instruction signal into the optical module 200. The optical module 200 first adjusts the second bias current according to the second command value or the third command value of the first instruction signal, and then readjusts the first bias current and the bias voltage to ensure that the template margin of the eye diagram is greater than the preset value.

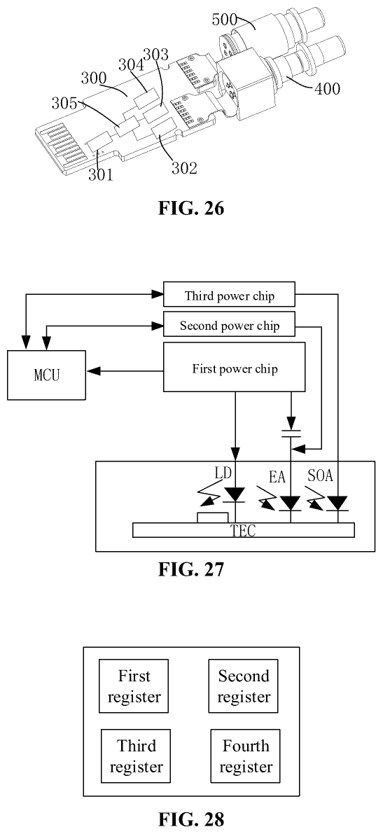

FIG. 25 is a structural diagram of an optical module without a shell according to some embodiments. FIG. 26 is another structural diagram of an optical module without a shell according to some embodiments. FIG. 27 is an assembly diagram of a laser chip, a power chip, and an MCU according to some embodiments. As shown in FIG. 25, FIG. 26 and FIG. 27, the optical emission component 400 includes a laser assembly. The laser assembly includes a laser chip. The laser chip includes only a light emission region. The light emission region emits light that does not carry data under the action of a first bias current and modulates the light that does not carry data into data-carrying light under the action of a modulation current.

In some embodiments, the optical emission component 400 includes a laser assembly. The laser assembly includes a laser chip. The laser chip includes a light emission region and a modulation region. The light emission region emits light that does not carry data under the action of a first bias current, and the modulation region performs electro-absorption modulation on the light that does not carry data under the action of a bias voltage and a modulation signal to obtain data-carrying light. The modulation signal is a modulation voltage.

In some embodiments, the optical emission component 400 includes a laser assembly. The laser assembly includes a laser chip. The laser chip includes a light emission region (LD), a modulation region (EA) and an amplifying region (SOA). The aforementioned first modulation unit and second modulation unit are arranged in the modulation region. The light emission region emits light that does not carry data under the action of a first bias current, the modulation region performs electro-absorption modulation on the light that does not carry data under the action of a bias voltage and a modulation signal to obtain data-carrying light, and the amplifying region amplifies the data-carrying light under the action of a second bias current.

To maintain the current PON 29 dB/32 dB link budget, the 50G PON standard imposes higher requirements on the optical power of the output light of the optical module with the OLT. Conventional 53 GBaud EMLs currently cannot meet the requirements of the optical power of the output light of the 50G PON. Therefore, the laser chip including the light emission region, the modulation region and the amplifying region is selected, as shown in FIG. 6, to meet the requirements of the optical power of the output light.

The circuit board 300 of the optical module is provided with an MCU 301, a first power chip 302, a second power chip 303 and a third power chip 304. The MCU 301 is separately connected to the first power chip 302, the second power chip 303 and the third power chip 304. The first power chip 302 is connected to only the light emission region and is configured to provide a first bias current to the light emission region, enabling the light emission region to emit light that does not carry data. The first power chip 302 provides the first bias current to only the light emission region. To provide the modulation signal to the modulation region, in some embodiments, the optical module further includes a driving chip. The driving chip is separately connected to the MCU 301 and the modulation region and is configured to provide a modulation signal to the modulation region. In some embodiments, the first power chip 302 is connected to both the light emission region and the modulation region. The power chip is configured to provide the first bias current to the light emission region and the modulation signal to the modulation region. Exemplarily, the first power chip 302 is an integrated chip that provides a first bias current and a bias voltage. In some embodiments, the second power chip 303 is connected to the modulation region and is configured to provide a bias voltage to the modulation region, enabling the modulation region to perform electro-absorption modulation on light that does not carry data under the action of a modulation voltage and a bias voltage to obtain data-carrying light.

Exemplarily, the third power chip 304 is connected to the amplifying region and is configured to provide a second bias current to the amplifying region, enabling the amplifying region to amplify the data-carrying light.

The second bias current has a greater impact on the optical power of the output light compared with the first bias current and the bias voltage. If the first bias current or the bias voltage is determined first and then the second bias current is adjusted, a test result may be inaccurate. Therefore, the second bias current is determined first, and then the first bias current and the bias voltage are debugged separately in case of keeping the second bias current unchanged. Since the first bias current has a greater impact on the optical power of the output light of the laser assembly compared with the bias voltage, the first bias current is coarsely debugged first, followed by coarse debugging of the bias voltage in case of determining the second bias current. However, coarsely debugging the bias voltage may cause the optical power of the output light to exceed the first preset range. Therefore, after coarsely debugging the bias voltage, the first bias current needs to be finely debugged to restore the optical power of the output light to the first preset range. However, finely debugging the first bias current may cause the extinction ratio to exceed the third preset range. Therefore, after finely debugging the first bias current, the bias voltage needs to be finely debugged. In other words, the MCU 301 is configured to: control the third power chip to determine the second bias current according to the first command value of the first instruction signal; control the first power chip to adjust the first bias current according to the first command value of the second instruction signal, such that the optical power of the output light of the laser assembly is within the first preset range; control the second power chip to adjust the bias voltage according to the first command value of the third instruction signal, such that the extinction ratio of the laser assembly is within the third preset range; control the first power chip to adjust the first bias current according to the second command value of the second instruction signal, such that the optical power of the output light is within the second preset range; and control the second power chip to adjust the bias voltage according to the second command value of the third instruction signal, such that the extinction ratio of the laser assembly is within the fourth preset range.

The second preset range is within the first preset range. When the optical power of the output light is within the second preset range, even if the bias voltage is further finely adjusted and the optical power of the output light exceeds the second preset range, the optical power of the output light will not exceed the first preset range, such that the optical power of the output light of the optical module meets the eye diagram metrics. The fourth preset range is within the third preset range. When the extinction ratio is within the fourth preset range, even if the first bias current is further adjusted and the extinction ratio exceeds the fourth preset range, the extinction ratio will not exceed the third preset range, such that the extinction ratio of the optical module meets the eye diagram metrics. The second bias current is determined, and the first bias current and the bias voltage are coarsely adjusted first and then finely adjusted in case of keeping the second bias current unchanged, such that both the optical power of the output light and the extinction ratio meet the eye diagram metrics of the optical module, thereby enabling the optical module to have good eye diagram quality.

In the present disclosure, the extinction ratio is increased in the above embodiments, thereby improving the eye diagram quality of the optical module. In addition to the extinction ratio, the metrics representing the eye diagram quality include a template margin. If the template margin is greater than the preset value, the template margin meets the eye diagram metrics. If the template margin is less than the preset value, the template margin does not meet the eye diagram metrics. In the present disclosure, embodiments for optimizing the template margin are also provided to further improve the eye diagram quality.

If the template margin of the optical module is greater than the preset value, the first command value of the first instruction signal, the second command value of the second instruction signal and the second command value of the third instruction signal are stored. In other words, the MCU is configured to store the first command value of the first instruction signal, the second command value of the second instruction signal and the second command value of the third instruction signal according to the fourth instruction signal.

If the template margin of the optical module is less than the preset value, i.e., the fourth instruction signal is not received, the third power chip is controlled to adjust the second bias current according to the second command value of the first instruction signal, and the first bias current and the bias voltage are readjusted, such that the optical power of the output light, the extinction ratio, and the template margin all meet the eye diagram requirements. Exemplarily, the MCU 301 is further configured to: control the third power chip to adjust the second bias current according to the second command value of the first instruction signal; control the first power chip to adjust the first bias current according to a third command value of the second instruction signal, such that the optical power of the output light is within the first preset range; control the second power chip to adjust the bias voltage according to a third command value of the third instruction signal, such that the extinction ratio is within the third preset range; control the first power chip to adjust the first bias current according to a fourth command value of the second instruction signal, such that the optical power of the output light is within the second preset range; control the second power chip to adjust the bias voltage according to a fourth command value of the third instruction signal, such that the extinction ratio is within the fourth preset range; and store the second command value of the first instruction signal, the third command value of the second instruction signal and the fourth command value of the third instruction signal according to the fourth instruction signal.

If the template margin of the optical module is still less than the preset value (i.e., the fourth instruction signal is still not received after the second bias current is adjusted according to the second command value of the first instruction signal and the first bias current and the bias voltage are adjusted), the third power chip is controlled to adjust the second bias current according to the third command value of the first instruction signal, and the first bias current and the bias voltage are readjusted, such that the optical power of the output light, the extinction ratio and the template margin all meet the eye diagram requirements. Exemplarily, the MCU 301 is further configured to: control the third power chip to adjust the second bias current according to the third command value of the first instruction signal; control the first power chip to adjust the first bias current according to a fifth command value of the second instruction signal, such that the optical power of the output light is within the first preset range; control the second power chip to adjust the bias voltage according to a fifth command value of the third instruction signal, such that the extinction ratio is within the third preset range; control the first power chip to adjust the first bias current according to a sixth command value of the second instruction signal, such that the optical power of the output light is within the second preset range; control the second power chip to adjust the bias voltage according to a sixth command value of the third instruction signal, such that the extinction ratio is within the fourth preset range; and store the third command value of the first instruction signal, the sixth command value of the second instruction signal and the sixth command value of the third instruction signal according to the fourth instruction signal.

The second bias current corresponding to the first command value of the first instruction signal, the second bias current corresponding to the second command value of the first instruction signal and the second bias current corresponding to the third command value of the first instruction signal have no difference in magnitude. However, the second bias current corresponding to the first command value of the first instruction signal is more suitable for most optical modules compared with the other two bias currents. The second bias current corresponding to the second command value of the first instruction signal is more suitable for the majority of the remaining optical modules compared with the second bias current corresponding to the third command value of the first instruction signal. One instruction signal has only one command value at a time, and cannot have two command values simultaneously.

FIG. 28 is a structural diagram of an MCU according to some embodiments. As shown in FIG. 28, in some embodiments, the MCU 301 includes a first register, a second register, a third register and a fourth register. The first register is configured to store the first instruction signal, the second register is configured to store the second instruction signal, the third register is configured to store the third instruction signal, and the fourth register is configured to store the fourth instruction signal.

The MCU 301 is further configured to: read the first instruction signal in the first register and send the first command value of the first instruction signal to the third power chip so as to determine the second bias current; read the second instruction signal in the second register and send the first command value of the second instruction signal to the first power chip so as to adjust the first bias current, such that the optical power of the output light is within the first preset range; read the third instruction signal in the third register and send the first command value of the third instruction signal to the second power chip so as to adjust the bias voltage, such that the extinction ratio is within the third preset range; read the second instruction signal in the second register and send the second command value of the second instruction signal to the first power chip so as to adjust the first bias current, such that the optical power of the output light is within the second preset range; read the third instruction signal in the third register and send the second command value of the third instruction signal to the second power chip so as to adjust the bias voltage, such that the extinction ratio is within the fourth preset range; and read the fourth instruction signal in the fourth register, and store the first command value of the first instruction signal, the second command value of the second instruction signal and the second command value of the third instruction signal. A fifth register is arranged in the first power chip, a sixth register is arranged in the second power chip, and a seventh register is arranged in the third power chip. The fifth register is configured to store the second instruction signal, the sixth register is configured to store the third instruction signal, and the seventh register is configured to store the first instruction signal.

The MCU 301 is further configured to: read and write the first command value of the first instruction signal into the seventh register to determine the second bias current; read and write the first command value of the second instruction signal into the fifth register to adjust the first bias current, such that the optical power of the output light is within the first preset range; read and write the first command value of the third instruction signal into the sixth register to adjust the bias voltage, such that the extinction ratio is within the third preset range; read and write the second command value of the second instruction signal into the fifth register to adjust the first bias current, such that the optical power of the output light is within the second preset range; read and write the second command value of the third instruction signal into the sixth register to adjust the bias voltage, such that the extinction ratio is within the fourth preset range; and read the fourth instruction signal, and store the first command value of the first instruction signal, the second command value of the second instruction signal and the second command value of the third instruction signal.

A digital-to-analog converter 305 is further arranged in the optical module. The digital-to-analog converter 305 is arranged on the circuit board 300. The digital-to-analog converter 305 is separately connected to the MCU, the first power chip, the second power chip and the third power chip, and is configured to convert digital signals into analog signals. The digital-to-analog converter is integrated into the MCU 301, and is separately connected to the first power chip, the second power chip and the third power chip.

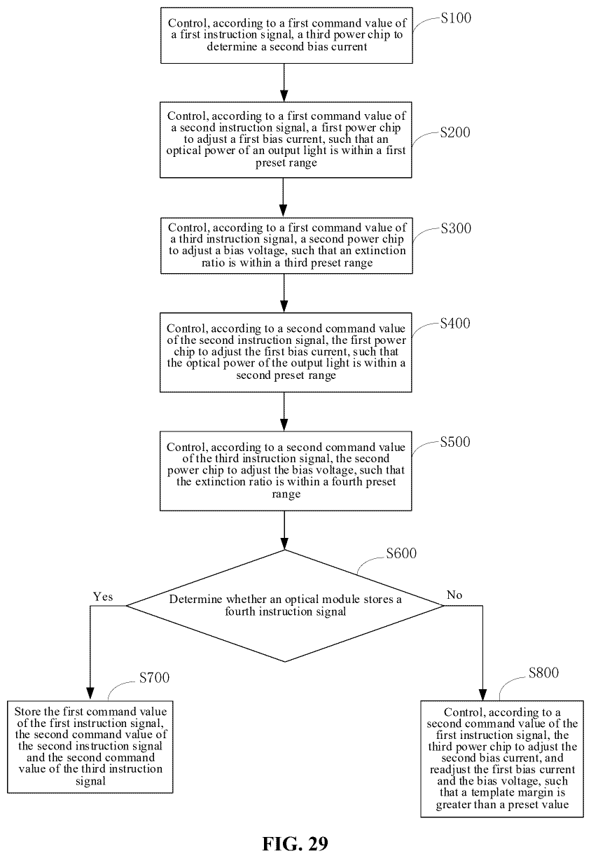

In addition to an optical module, the present disclosure provides a debugging method. FIG. 29 is a flowchart 1 of a debugging method according to some embodiments. As shown in FIG. 29, in some embodiments, the debugging method includes the following steps.

In S100, the third power chip is controlled to determine the second bias current according to the first command value of the first instruction signal.

The second bias current has a greater impact on the optical power of the output light compared with the first bias current and the bias voltage. If the first bias current or the bias voltage is determined first and then the second bias current is adjusted, a test result may be inaccurate. Therefore, the second bias current is determined first, and then the first bias current and the bias voltage are debugged separately in case of keeping the second bias current unchanged.

The first instruction signal is configured to characterize the second bias current. The test host writes the first command value of the first instruction signal into the first register of the MCU. The MCU reads the first command value of the first instruction signal and writes it into the seventh register of the third power chip. The third power chip determines the magnitude of the output second bias current according to the first command value of the first instruction signal.

In S200, the first power chip is controlled to adjust the first bias current according to the first command value of the second instruction signal, such that the optical power of the output light is within the first preset range. Since the first bias current has a greater impact on the optical power of the output light compared with the bias voltage, the first bias current is coarsely debugged first, followed by coarse debugging of the bias voltage in case of determining the second bias current.

The second instruction signal is configured to characterize the first bias current. The test host writes the first command value of the second instruction signal into the second register of the MCU. The MCU reads the first command value of the second instruction signal and writes it into the fifth register of the first power chip. The first power chip adjusts the magnitude of the output first bias current according to the first command value of the second instruction signal, such that the optical power of the output light is within the first preset range.

In S300, the second power chip is controlled to adjust the bias voltage according to the first command value of the third instruction signal, such that the extinction ratio is within the third preset range.

The third instruction signal is configured to characterize the bias voltage.

When the test host reads that the optical power of the output light from the oscilloscope is within the first preset range, the test host writes the first command value of the third instruction signal into the third register of the MCU. The MCU reads the first command value of the third instruction signal and writes it into the sixth register of the second power chip. The second power chip adjusts the magnitude of the output bias voltage according to the first command value of the third instruction signal, such that the extinction ratio is within the third preset range.

In S400, the first power chip is controlled to adjust the first bias current according to the second command value of the second instruction signal, such that the optical power of the output light is within the second preset range. Coarsely debugging the bias voltage may cause the optical power of the output light to exceed the first preset range. Therefore, after coarsely debugging the bias voltage, the first bias current needs to be finely debugged to restore the optical power of the output light to the first preset range. When the test host reads that the extinction ratio from the oscilloscope is within the third preset range, the test host writes the second command value of the second instruction signal into the second register of the MCU. The MCU reads the second command value of the second instruction signal and writes it into the fifth register of the first power chip. The first power chip adjusts the magnitude of the output first bias current according to the second command value of the second instruction signal, such that the optical power of the output light is within the second preset range.

In S500, the second power chip is controlled to adjust the bias voltage according to the second command value of the third instruction signal, such that the extinction ratio is within the fourth preset range.

Finely debugging the first bias current may cause the extinction ratio to exceed the third preset range. Therefore, after finely debugging the first bias current, the bias voltage needs to be finely debugged. When the test host reads that the optical power of the output light from the oscilloscope is within the second preset range, the test host writes the second command value of the third instruction signal into the third register of the MCU. The MCU reads the second command value of the third instruction signal and writes it into the sixth register of the second power chip. The first power chip adjusts the magnitude of the output bias voltage according to the second command value of the third instruction signal, such that the extinction ratio is within the fourth preset range.

In S600, it is determined whether the optical module stores the fourth instruction signal.

When the test host reads that the extinction ratio from the oscilloscope is within the third preset range and the template margin is greater than the preset value, the test host writes the fourth instruction signal into the fourth register of the MCU. When the MCU reads the fourth instruction signal, it indicates that the optical power of the output light, the extinction ratio and the template margin all meet the eye diagram metrics.

When the test host reads that the extinction ratio from the oscilloscope is within the third preset range and the template margin is less than the preset value, the test host does not write the fourth instruction signal into the fourth register of the MCU, but writes the second command value of the first instruction signal into the first register. When the MCU does not read the fourth instruction signal, it indicates that although the optical power of the output light and the extinction ratio meet the eye diagram metrics, the template margin does not meet the eye diagram metrics. Since the template margin is related to the first bias current, the second bias current and the bias voltage, the first bias current, the second bias current and the bias voltage are readjusted.

In S700, if the optical module stores the fourth instruction signal, the first command value of the first instruction signal, the second command value of the second instruction signal and the second command value of the third instruction signal are stored.

In S800, if the optical module does not store the fourth instruction signal, the third power chip is controlled to adjust the second bias current according to the second command value of the first instruction signal, and the first bias current and the bias voltage are readjusted, such that the template margin is greater than the preset value.

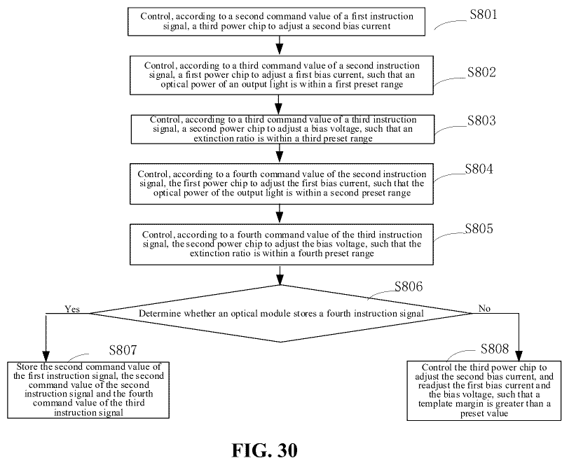

FIG. 30 is a flowchart 2 of a debugging method according to some embodiments. As shown in FIG. 30, in some embodiments, if the template margin of the optical module is less than the preset value, as in S800, the debugging method includes:
S801: controlling the third power chip to adjust the second bias current according to the second command value of the first instruction signal;
S802: controlling the first power chip to adjust the first bias current according to the third command value of the second instruction signal, such that the optical power of the output light is within the first preset range;
S803: controlling the second power chip to adjust the bias voltage according to the third command value of the third instruction signal, such that the extinction ratio is within the third preset range;
S804: controlling the first power chip to adjust the first bias current according to the fourth command value of the second instruction signal, such that the optical power of the output light is within the second preset range;
S805: controlling the second power chip to adjust the bias voltage according to the fourth command value of the third instruction signal, such that the extinction ratio is within the fourth preset range;
S806: determining whether the optical module stores the fourth instruction signal;
S807: if the optical module stores the fourth instruction signal, storing the second command value of the first instruction signal, the fourth command value of the second instruction signal and the fourth command value of the third instruction signal; and
S808: if the optical module does not store the fourth instruction signal, controlling the third power chip to adjust the second bias current, and readjusting the first bias current and the bias voltage, such that the template margin is greater than the preset value.

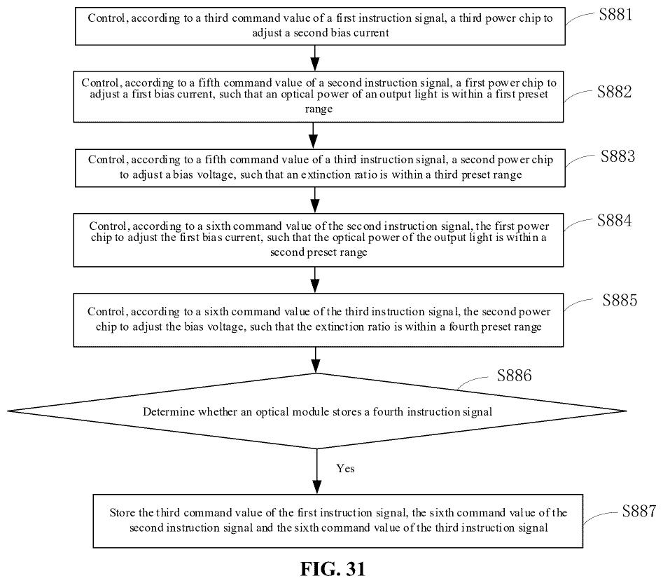

FIG. 31 is a flowchart 3 of a debugging method according to some embodiments. As shown in FIG. 31, in some embodiments, if the template margin of the optical module is less than the preset value, as in S808, the debugging method includes:
S881: controlling the third power chip to adjust the second bias current according to the third command value of the first instruction signal;
S882: controlling the first power chip to adjust the first bias current according to the fifth command value of the second instruction signal, such that the optical power of the output light is within the first preset range;
S883: controlling the second power chip to adjust the bias voltage according to the fifth command value of the third instruction signal, such that the extinction ratio is within the third preset range;
S884: controlling the first power chip to adjust the first bias current according to the sixth command value of the second instruction signal, such that the optical power of the output light is within the second preset range;
S885: controlling the second power chip to adjust the bias voltage according to the sixth command value of the third instruction signal, such that the extinction ratio is within the fourth preset range;
S886: determining whether the optical module stores the fourth instruction signal; and
S887: if the optical module stores the fourth instruction signal, storing the third command value of the first instruction signal, the sixth command value of the second instruction signal and the sixth command value of the third instruction signal; or if the optical module does not store the fourth instruction signal, ending the process.

Finally, it should be noted that the above embodiments are provided merely to illustrate the technical solutions of the present disclosure and not to limit them. Although the present disclosure has been described in detail with reference to the aforementioned embodiments, those of ordinary skill in the art should understand that they can still make modifications on the technical solutions described in the aforementioned embodiments or make equivalent replacements on some of the technical features; and these modifications or replacements do not make the essence of the corresponding technical solutions depart from the spirit and scope of the technical solutions of the various embodiments of the present disclosure.

What is claimed is:

1. An optical module, comprising:
a circuit board, a surface of which is arranged thereon with a driver, wherein the driver comprises a first output terminal and a second output terminal, and the driver is configured to output a first modulation signal through the first output terminal, and output a second modulation signal through the second output terminal;
an optical emission component electrically connected to the circuit board and comprising a laser assembly, wherein the laser assembly comprises a first modulation unit and a second modulation unit; an optical output terminal of the first modulation unit is optically connected to an optical input terminal of the second modulation unit; the first modulation unit is connected to the first output terminal via a first path, and the second modulation unit is connected to the second output terminal via a second path;
wherein the first modulation unit is configured to perform a first modulation according to the first modulation signal and output a first optical signal; the second modulation unit is configured to perform a second modulation on the first optical signal according to the second modulation signal; and the first modulation and the second modulation are co-directional modulations such that optical power modulations of optical signals corresponding to a same bit signal are superimposed; and
wherein the first modulation and the second modulation are co-directional modulations that comprise: the first modulation signal and the second modulation signal are differential signals with opposite phases, and modulation characteristics of the first modulation unit and the second modulation unit are different; or, the first modulation signal and the second modulation signal are differential signals with opposite phases, and the modulation characteristics of the first modulation unit and the second modulation unit are the same, and a phase inversion circuit is connected in series on the first path or the second path; or, the first modulation signal and the second modulation signal are signals with the same phase, and the modulation characteristics of the first modulation unit and the second modulation unit are the same; or, the first modulation signal and the second modulation signal are signals with the same phase, and the modulation characteristics of the first modulation unit and the second modulation unit are different, and a phase inversion circuit is connected in series on the first path or the second path.

2. The optical module according to claim 1, wherein the first modulation signal and the second modulation signal are differential signals with opposite phases; the laser assembly further comprises an LD, which is enable to generate a direct current light when an anode of the LD is supplied with a bias current; the first modulation unit comprises an EAM, the second modulation unit comprises an SOA, and modulation characteristics of the EAM and the SOA are different;
the EAM is located at an optical output terminal of the LD, and an anode of the EAM is connected to the first output terminal via the first path such that the EAM performs the first modulation on the direct current light generated by the LD according to the first modulation signal and generates the first optical signal;
the SOA is located at an optical output terminal of the EAM, an anode of the SOA is supplied with a bias current, and the anode of the SOA is also connected to the second output terminal via the second path such that the SOA amplifies and performs the second modulation on the first optical signal according to the second modulation signal.

3. The optical module according to claim 1, wherein the first modulation signal and the second modulation signal are signals with the same phase, the laser assembly further comprises an LD, which is enabled to generate a direct current light as an anode of the LD is supplied with a bias current; the first modulation unit comprises an EAM, the second modulation unit comprises an SOA, and modulation characteristics of the EAM and the SOA are different;
the EAM is located at an optical output terminal of the LD, an anode of the EAM is connected to the first output terminal via the first path, and the phase inversion circuit is arranged on the first path such that the EAM performs the first modulation on the direct current light generated by the LD based on the first modulation signal after phase inversion, and generates the first optical signal;
the SOA is located at an optical output terminal of the EAM, an anode of the SOA is supplied with a bias current, and the anode of the SOA is also connected to the second output terminal via the second path such that the SOA amplifies and performs the second modulation on the first optical signal based on the second modulation signal.

4. The optical module according to claim 1, wherein the first modulation signal and the second modulation signal are signals with the same phase, the laser assembly further comprises an LD, which is enabled to generate a direct current light as an anode of the LD is supplied with a bias current; the first modulation unit comprises an EAM, the second modulation unit comprises an SOA, and modulation characteristics of the EAM and the SOA are different;
the EAM is located at an optical output terminal of the LD, and an anode of the EAM is connected to the first output terminal via the first path such that the EAM performs the first modulation on the direct current light generated by the LD according to the first modulation signal and generates the first optical signal;
the SOA is located at an optical output terminal of the EAM, an anode of the SOA is supplied with a bias current, and the anode of the SOA is also connected to the second output terminal via the second path; the phase inversion circuit is arranged on the second path such that the SOA amplifies and performs the second modulation on the first optical signal based on the second modulation signal after phase inversion.

5. The optical module according to claim 2, wherein the first path via which the anode of the EAM is connected to the first output terminal plus a distance from the EAM to the SOA is equal to the second path via which the anode of the SOA is connected to the second output terminal.

6. The optical module according to claim 2, wherein the first output terminal of the driver is a non-inverting output terminal, and the second output terminal of the driver is an inverting output terminal; or
the first output terminal of the driver is an inverting output terminal, and the second output terminal of the driver is a non-inverting output terminal.

7. The optical module according to claim 1, wherein the first modulation signal and the second modulation signal are differential signals with opposite phases, the first modulation unit comprises an LD, the second modulation unit comprises an EAM, and the LD and the EAM have different modulation characteristics;
an anode of the LD is supplied with a bias current, and the anode of the LD is connected to the first output terminal such that the LD performs the first modulation on the direct current light generated by the LD based on the first modulation signal and generates the first optical signal;
the EAM is located at an optical output terminal of the LD, and an anode of the EAM is connected to the second output terminal such that the EAM performs the second modulation on the first optical signal based on the second modulation signal;
or, the laser assembly further comprises an SOA that is located at an optical output terminal of the EAM, and the SOA can amplify an optical signal modulated by the EAM as an anode of the SOA is supplied with a bias current.

8. The optical module according to claim 1, wherein the first modulation unit comprises an LD, the second modulation unit comprises an EAM, and the LD and the EAM have different modulation characteristics;
an anode of the LD is supplied with a bias current, and the anode of the LD is connected to the first output terminal via the first path;
the EAM is located at an optical output terminal of the LD, and an anode of the EAM is connected to the second output terminal via the second path;
wherein, in a case that the first modulation signal and the second modulation signal are signals with the same phase, the phase inversion circuit is arranged on the first path or the second path;
or, the laser assembly further comprises an SOA that is located at an optical output terminal of the EAM, and the SOA can amplify an optical signal modulated by the EAM as an anode of the SOA is supplied with a bias current.

9. The optical module according to claim 1, wherein the laser assembly further comprises an LD, which is enabled to generate a direct current light as an anode of the LD is supplied with a bias current; the first modulation unit comprises a first EAM, the second modulation unit comprises a second EAM, and modulation characteristics of the first EAM and the second EAM are the same;
the first EAM is located at an optical output terminal of the LD, and an anode of the first EAM is connected to the first output terminal via the first path;
the second EAM is located at an optical output terminal of the first EAM, and an anode of the second EAM is connected to the second output terminal via the second path;
wherein in a case that the first modulation signal and the second modulation signal are differential signals with opposite phases, the phase inversion circuit is connected in series on the first path or the second path.

10. The optical module according to claim 1, wherein the first modulation signal and the second modulation signal are signals with the same phase; the laser assembly further comprises an LD, which is enabled to generate a direct current light as an anode of the LD is supplied with a bias current; the first modulation unit comprises a first EAM, the second modulation unit comprises a second EAM, and the first EAM and the second EAM have the same modulation characteristics;
the first EAM is located at an optical output terminal of the LD, and an anode of the first EAM is connected to the first output terminal via the first path;
the second EAM is located at an optical output terminal of the first EAM, and an anode of the second EAM is connected to the second output terminal via the second path.

11. The optical module according to claim 6, wherein the driver is integrated in a DSP chip that is arranged on the circuit board; or the driver is a separate driver chip;
a first capacitor is connected in series between the inverting output terminal and the anode of the SOA, and a second capacitor is connected in series between the non-inverting output terminal and the anode of the EAM;
the optical emission component further comprises a TEC, and the laser assembly is arranged on the TEC; and
the phase inversion circuit includes an inverter.

12. The optical module according to claim 1, wherein
the optical module further comprises an optical accommodation component and an optical reception component, and wherein the optical reception component comprises a first optical reception assembly, a second optical reception assembly and a third optical reception assembly that are arranged at a side of the optical accommodation component; and
the optical emission component further comprises a light emission cavity, one end of the light emission cavity being connected to the optical accommodation component, and the laser assembly is arranged in the light emission cavity; and a first laser assembly and a second laser assembly are arranged in the light emission cavity.

13. The optical module according to claim 12, wherein an electrical connector is arranged at one end of the light emission cavity away from the optical accommodation component, the electrical connector is embedded on a side wall of the light emission cavity, with one end of the electrical connector extending into the light emission cavity, and another end of the electrical connector locating outside the light emission cavity, and the end of the electrical connector locating outside the light emission cavity is electrically connected to the circuit board.

14. The optical module according to claim 1, wherein the laser assembly comprises a modulation region, in which the first modulation unit and the second modulation unit are located; and the laser assembly further comprises a light emission region and an amplifying region;
the optical module further comprises:
a first power chip connected to the light emission region and configured to provide a first bias current to the light emission region;
a second power chip connected to the modulation region and configured to provide a bias voltage to the modulation region;
a third power chip connected to the amplifying region and configured to provide a second bias current to the amplifying region;
an MCU connected to the first power chip, the second power chip and the third power chip, respectively, and the MCU is configured to:
control, according to a first command value of a first instruction signal, the third power chip so as to provide the second bias current;
control, according to a first command value of a second instruction signal, the first power chip to adjust the first bias current such that an optical power of an output light of the laser assembly is within a first preset range;
control, according to a first command value of the third instruction signal, the second power chip to adjust the bias voltage such that an extinction ratio of the laser assembly is within a third preset range;
control, according to a second command value of the second instruction signal, the first power chip to adjust the first bias current such that the optical power of an output light of the laser assembly is within a second preset range; and
control, according to a second command value of the third instruction signal, the second power chip to adjust the bias voltage such that the extinction ratio of the laser assembly is within a fourth preset range.

15. The optical module according to claim 14, wherein the MCU is further configured to:
store, according to a fourth instruction signal, the first command value of the first instruction signal, the second command value of the second instruction signal, and the second command value of the third instruction signal, wherein the fourth instruction signal is configured to indicate that a template margin of an eye diagram exceeds a preset value;
control, according to the second command value of the first instruction signal, the third power chip to adjust the second bias current and readjust the first bias current and bias voltage, if it does not receive the fourth instruction signal; wherein the second preset range is within the first preset range, and the fourth preset range is within the third preset range.

16. The optical module according to claim 15, wherein the MCU is further configured to:
control, according to the second command value of the first instruction signal, the third power chip to adjust the second bias current;
control, according to a third command value of the second instruction signal, the first power chip to adjust the first bias current such that the optical power of the output light of the laser assembly is within the first preset range;
control, according to a third command value of the third instruction signal, the second power chip to adjust the bias voltage such that the extinction ratio of the laser assembly is within the third preset range;
control, according to a fourth command value of the second instruction signal, the first power chip to adjust the first bias current such that the optical power of the output light of the laser assembly is within the second preset range;
control, according to a fourth command value of the third instruction signal, the second power chip to adjust the bias voltage such that the extinction ratio of the laser assembly is within the fourth preset range; and
store the second command value of the first instruction signal, the third command value of the second instruction signal, and the fourth command value of the third instruction signal according to the fourth instruction signal.

17. The optical module according to claim 16, wherein the MCU is further configured to:
control, according to the third command value of the first instruction signal, the third power chip to adjust the second bias current;
control, according to a fifth command value of the second instruction signal, the first power chip to adjust the first bias current such that the optical power of the output light of the laser assembly is within the first preset range;
control, according to a fifth command value of the third instruction signal, the second power chip to adjust the bias voltage such that the extinction ratio of the laser assembly is within the third preset range;
control, according to a sixth command value of the second instruction signal, the first power chip to adjust the first bias current such that the optical power of the output light of the laser assembly is within the second preset range;
control, according to a sixth command value of the third instruction signal, the second power chip to adjust the bias voltage such that the extinction ratio of the laser assembly is within the fourth preset range; and
store the third command value of the first instruction signal, the sixth command value of the second instruction signal and the sixth command value of the third instruction signal according to the fourth instruction signal.

18. The optical module according to claim 14, wherein the MCU is disposed therein with a first register, a second register, a third register and a fourth register, wherein the first register is configured to store the first instruction signal, the second register is configured to store the second instruction signal, the third register is configured to store the third instruction signal, and the fourth register is configured to store the fourth instruction signal; and the MCU is further configured to:
read the first instruction signal in the first register, and send the first command value of the first instruction signal to the third power chip so as to determine the second bias current;
read the second instruction signal in the second register, and send the first command value of the second instruction signal to the first power chip so as to adjust the first bias current, thereby making the optical power of the output light of the laser assembly within the first preset range;
read the third instruction signal in the third register, and send the first command value of the third instruction signal to the second power chip so as to adjust the bias voltage, thereby making the extinction ratio of the laser assembly within the third preset range;
read the second instruction signal in the second register, and send the second command value of the second instruction signal to the first power chip so as to adjust the first bias current, thereby making the optical power of the output light of the laser assembly within the second preset range;
read the third instruction signal in the third register, and send the second command value of the third instruction signal to the second power chip so as to adjust the bias voltage, thereby making the extinction ratio of the laser assembly within the fourth preset range; and
read the fourth instruction signal in the fourth register, and store the first command value of the first instruction signal, the second command value of the second instruction signal, and the second command value of the third instruction signal.

19. The optical module according to claim 14, further comprising a digital-to-analog converter, and the digital-to-analog converter is connected to the MCU, the first power chip, the second power chip and the third power chip, respectively.

20. The optical module according to claim 14, wherein the first power chip is disposed therein with a fifth register, the second power chip is disposed therein with a sixth register, and the third power chip is disposed therein with a seventh register; and the MCU is configured to:
read and write the first command value of the first instruction signal into the seventh register to determine the second bias current;
read and write the first command value of the second instruction signal into the fifth register to adjust the first bias current such that the optical power of the output light of the laser assembly is within the first preset range;
read and write the first command value of the third instruction signal into the sixth register to adjust the bias voltage such that the extinction ratio of the laser assembly is within the third preset range;
read and write the second command value of the second instruction signal into the fifth register to adjust the first bias current such that the optical power of the output light of the laser assembly is within the second preset range;
read and write the second command value of the third instruction signal into the sixth register to adjust the bias voltage such that the extinction ratio of the laser assembly is within the fourth preset range; and
read the fourth instruction signal, and store the first command value of the first instruction signal, the second command value of the second instruction signal, and the second command value of the third instruction signal.
